(19) United States
(12) Patent Application Publication
(10) Pub. No.: US 2022/0335438 A1
(43) Pub. Date: Oct. 20, 2022

(54) RETAINING USER VALUE THROUGH USER SUPPORT INTERACTION ANALYTICS

(71) Applicant: The Fin Exploration Company, San Francisco, CA (US)

(72) Inventors: Samuel Lessin, San Francisco, CA (US); Andrew Kortina, San Francisco, CA (US)

(21) Appl. No.: 17/723,391

(22) Filed: Apr. 18, 2022

Related U.S. Application Data
(60) Provisional application No. 63/177,231, filed on Apr. 20, 2021.

(51) Int. Cl. G06Q 30/00; G06Q 30/02; G06Q 10/06

(52) U.S. Cl. CPC G06Q 30/016; G06Q 30/0201; G06Q 10/06398

(57) ABSTRACT

Methods, systems, and apparatus, including computer programs encoded on computer storage media, for retaining user value by leveraging support interaction data. One of the methods includes receiving user support interaction data derived from specified user support interactions and user information not derived from the specified user support interactions. Expected value of the user to an entity is determined assuming the specified user support interactions did not occur and given that the specified user support interactions did occur. Action data is generated. The action data is generated based on the user support interaction data, the user information not derived from the specified user support interaction, the expected value of the user to the entity assuming the specified user support interactions did not occur, and the expected value of the user to the entity given that the specified user support interactions did occur. Action is taken based on the action data.

### CROSS-REFERENCE TO RELATED APPLICATION

This application claims priority to U.S. Provisional Patent Application No. 63/177,231, filed Apr. 20, 2021, the entire contents of which are incorporated herein by reference.

### BACKGROUND

### Technical Field

This specification relates to retaining user value and improving user support systems and management by leveraging user support interaction data.

### Background

Operations or customer service teams are generally concerned with both quality and efficiency. Efficiency can be measured using key performance indicators (KPIs) such as Cost Per Resolution (CPR) and Average Handle Time (AHT). Measuring the quality of a service experience can be more subjective than measuring efficiency. Common methods for measuring quality can involve the use of surveys. Using surveys, different quality KPIs can be computed, such as CSAT (Customer Satisfaction Score (e.g., CSS), NPS (Net Promoter Score), and CES (Customer Effort Score). CSAT or CSS surveys can include questions such as: “On a scale of 1 (very dissatisfied) to 5 (very satisfied), how would you rate your overall satisfaction with the service you received?”. NPS surveys can include questions such as: “On a scale of 1 (not likely) to 10 (very likely), how likely are you to recommend our service to a friend or colleague?”. CES surveys can included questions such as: “On a scale of 1 (very high effort) to 5 (very low effort), how easy was it for you to resolve your issue?”.

### SUMMARY

This specification describes technologies for retaining user value by leveraging user support interaction data. These technologies generally involve using an analysis system that automatically analyzes, for example, support interaction data from user support interactions, other user information, and a change in expected value of the user that is predicted to occur after the support interactions. Various types of actions can be taken based on action data generated by the analysis system. For example, different actions can be taken with respect to particular support representatives, teams, and tools based on which representatives, teams, and tools correlate with increased user retention, maintaining users, or increased user value.

In general, one innovative aspect of the subject matter described in this specification can be embodied in methods that include the actions of: receiving user support interaction data derived from specified user support interactions; receiving user information not derived from the specified user support interactions; determining expected value of the user to an entity assuming the specified user support interactions did not occur; determining the expected value of the user to the entity given that the specified user support interactions did occur; generating action data based on i) the user support interaction data, ii) the user information not derived from the specified user support interaction, iii) the expected value of the user to the entity assuming the specified user support interactions did not occur, and iv) the expected value of the user to the entity given that the specified user support interactions did occur; and taking action based on the action data.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The subject matter described in this specification can be implemented in particular embodiments so as to realize one or more of the following advantages. An analysis system can be used by an organization to eliminate (or reduce) customer bias by using existing support interaction data based on support representative behaviors rather than using unreliable customer surveys to predict quality of the support interactions. In some cases, the analysis system includes a trained model that is trained on collected support interactions. Training the model based on collected support interactions can result in a more reliable and a larger quantity of data as compared to customer surveys or other approaches. Interaction data can be collected and used by the analysis system in real time rather than analyzing interactions after the interactions have occurred. The analysis system can distinguish between: 1) issues, effects, and customer experience with support interactions; and 2) customer issues or concerns with a product or service for which a support case is initiated. The analysis system can determine a correlation between customer satisfaction and recurring business, including determining an expected value of the customer assuming the support interactions occurred and an expected value of the customer assuming no support interactions occurred. The analysis system can determine support interactions that result in desired outcomes, such as user value increase or user retention. Actions can be performed based on outputs of the analysis system, to realize desired outcomes. Costs for customer support actions and other investment in customer support can be allocated so as to maximize return on investment with respect to increased or retained user value. The analysis system can automatically perform analysis on data sets that would not be practical (or possible, in a useful timeframe) to process manually. For example, the analysis system can perform analysis for workforces that include, for instance, thousands of users. As another example, the analysis system can analyze tracked activity data that can include many thousands of data points based on tracking user activity and events for a variety of heterogeneous tools. Activity can be tracked and analyzed per user for numerous tools. For example, a given user may use twelve, fifteen, or some other number of heterogeneous tools, including third party tools, while performing their work.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example of a workforce analytics system that can be used to determine discrete time spent by customer service agents on different tasks across different systems and produce reports based on discretized time, according to some implementations of the present disclosure.

FIG. 1B shows an example of a workforce analytics manager (WAM), according to some implementations of the present disclosure.

FIG. 2 is a screenshot of a customer screen for handling cases in the workforce analytics system 100, according to some implementations of the present disclosure.

FIG. 3 is a screen shot of an example of a search analytics page for looking up customer service agent events, according to some implementations of the present disclosure.

FIG. 4 is a screen shot of an example of a dashboard for customer service agent time spent on cases, according to some implementations of the present disclosure.

FIG. 5 is a screen shot of an example of a focus events structure, according to some implementations of the present disclosure.

FIGS. 6A-6B are screen shots collectively showing an example of a true utilization page, according to some implementations of the present disclosure.

FIGS. 7A-7B are screen shots collectively showing an example of a true handle time page, according to some implementations of the present disclosure.

FIGS. 8A-8B are screen shots collectively showing an example of an outliers page, according to some implementations of the present disclosure.

FIG. 9 is a screen shot of an example of a customer service agent summary page, according to some implementations of the present disclosure.

FIG. 10A is a screen shot of an example of a process flow diagram, according to some implementations of the present disclosure.

FIG. 10B is a screen shot of an example of a process timeline, according to some implementations of the present disclosure.

FIG. 11 is a screen shot of an example of a resource analysis page, according to some implementations of the present disclosure.

FIG. 12 is a screen shot of an example of a trigger event definition page, according to some implementations of the present disclosure.

FIG. 13 is a screen shot of an example of a clickstream page, according to some implementations of the present disclosure.

FIG. 14A is a screen shot of an example of a case defining services per organization page, according to some implementations of the present disclosure.

FIG. 14B is a screen shot showing an example of a document object model (DOM) tools page, according to some implementations of the present disclosure.

FIG. 14C is a screen shot showing an example of an add DOM fingerprint page, according to some implementations of the present disclosure.

FIG. 15 is a flowchart of an example of a method for determining time spent by the customer service agent on the particular case, according to some implementations of the present disclosure.

FIG. 16 is a block diagram illustrating an environment that includes a user support improvement system.

FIG. 17 is a diagram of the components of an exemplary user support improvement system.

FIG. 18 is a flowchart of a process for retaining user value through user support interaction analytics.

FIG. 19A is a graph of weekly spend decreased after a user support interaction.

FIG. 19B is a graph of weekly spend largely unchanged after a user support interaction.

FIG. 20 is a block diagram of an example computer system used to provide computational functionalities associated with described algorithms, methods, functions, processes, flows, and procedures described in the present disclosure.

Like reference numbers and designations in the various drawings indicate like elements.

### DETAILED DESCRIPTION

Although surveys can be used by an organization to obtain information about quality, there can be problems with survey-based quality metrics. As a first example, survey response data can be sparse, because often not everyone who is provided an opportunity to complete a survey actually completes the survey. For instance, a 20-40% survey completion rate is often considered a high completion rate. Actual survey response rates are often be less than 10%. As a second example, there can often be a lag time in receiving survey completion data, based on waiting for actual survey completion.

As a third example of problems with survey-based quality metrics, challenges can occur when attempting to discern whether a survey represents satisfaction with a customer service experience or an experience of the actual product or service about which a customer is contacting a support service. If a customer is contacting a support service, there likely has already been a product or service issue and the customer is likely already upset, frustrated, or otherwise at least partially dissatisfied. Accordingly, a survey-based quality metric may reflect product or service issues just as much as (if not more than) the quality of the customer service experience itself.

As a fourth example of problems with survey-based quality metrics, survey data may largely be a subjective expression of particular customers rather than indicative of all customers. For example, vocal customers who are more likely to contact support may provide more (and likely more negative feedback) than typical customers. If the vocal customers are not representative of the broader customer base, quality data may be biased and/or inaccurate. For example, vocal customers may use particular product or service features or may be more likely to experience particular issues than other customers.

As a fifth example of problems with survey-based quality metrics, quality surveys do not inform about an actual dollar value of a predicted correlation of a survey result to repeat business. For example, survey metrics do not inform how much more business is expected next month for a first customer who provides an experience score, for example, of ten (out of ten) as compared to a second customer who provides an experience score of one. Accordingly, without a mapping of a survey quality metric to an actual expected dollar value, survey quality metrics generally are not useful for determining or predicting how much to invest in improved customer support tools, training, and processes.

To solve or counter various problems with survey-based metrics, an analysis system described herein can include use of technologies for retaining user value by leveraging user support interaction data. For example, the analysis system can analyze support interaction data from user support interactions, other user information, and a change in expected value of the user that is predicted to occur after the support interactions. Various types of actions can be taken based on action data generated by the analysis system. For example, different actions can be taken with respect to particular support representatives, teams, and tools based on which representatives, teams, and tools correlate with increased user retention and/or increased user value.

The analysis system can leverage purchasing data of customers before and after support interactions. In some cases, use of the analysis system can involve training a machine learning model to learn inputs that result in a desired output (e.g., interactions that result in retaining users and/or maintaining or increasing user value), rather than relying on, for example, survey-based data. The analysis system can be used in place of, or in addition to survey-based results such as predicting CSAT approaches that attempt to predict repeat business. Rather than using CSAT as a proxy for predicting repeat business, the analysis system can predict, for example, which behaviors actually result in repeat business.

The analysis system can predict, for example, that certain behaviors result in a certain amount of retained or expanded user value. Accordingly, an organization can determine to invest a certain amount in training and other activities to replicate such behavior, thus realizing an effective return in investment. Investing in quality of customer service to implement productive behaviors can be seen as similar to investment based on LTV (Long Term Value). An LTV prediction can predict a net lifetime profit for a customer, and an LTV approach can recommend spending, for an acquisition cost, a value up to the LTV, since any difference between the LTV and the acquisition cost can be seen as an eventual profit.

Investing in quality improvement actions (e.g., actions recommended by the analysis system) can result in a faster return on investment than LTV approaches, since quality investments which are predicted to result in increased or maintained user value can be realized more quickly than longer LTV approaches. The analysis system can identify investments in customer service quality that are likely to retain a certain amount of user value, for example. Additionally, the analysis system can be used in real time. For example, the analysis system can estimate an amount of retained or increased user value and a real time action can be performed if the amount of retained or increased user value is greater than a cost of a real time change in handling of a support case. For instance, a case can be transferred to a live phone channel from a chat if the analysis system determines that changing the channel would result in a greater expected value change or retention than an increase of cost for handling the case using the phone channel as compared to the chat channel.

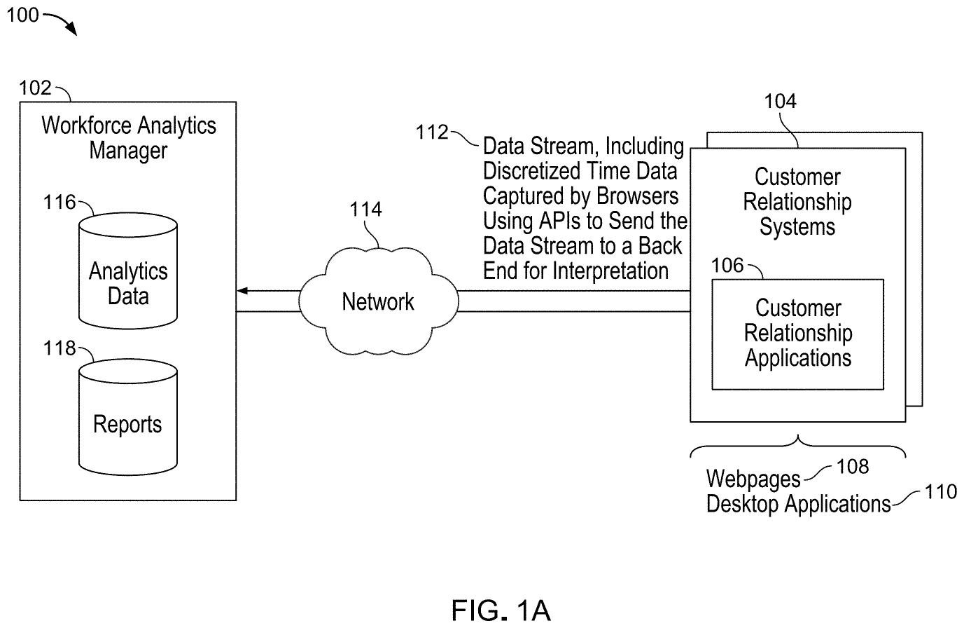

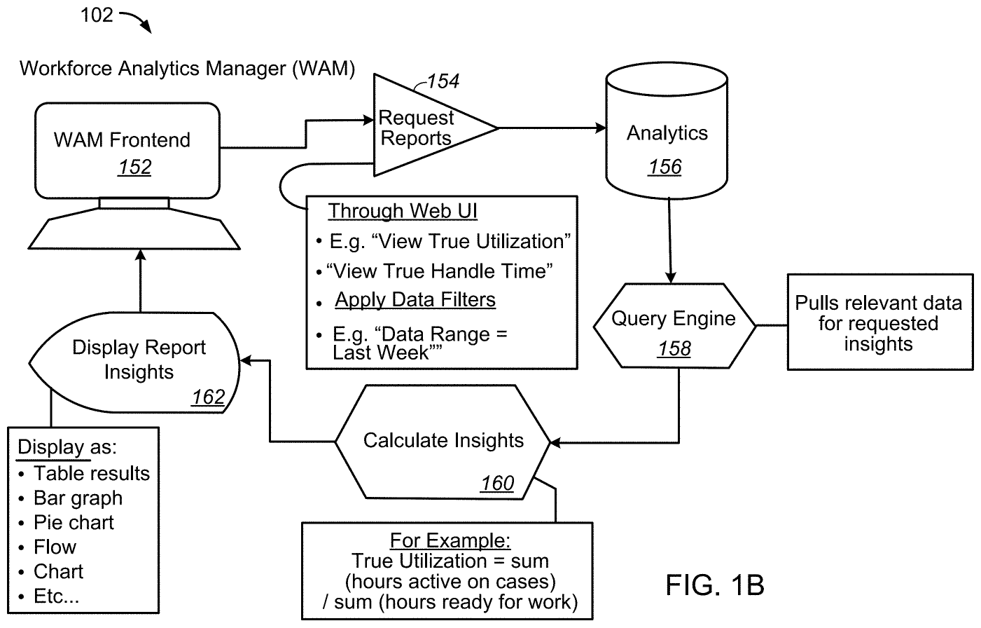

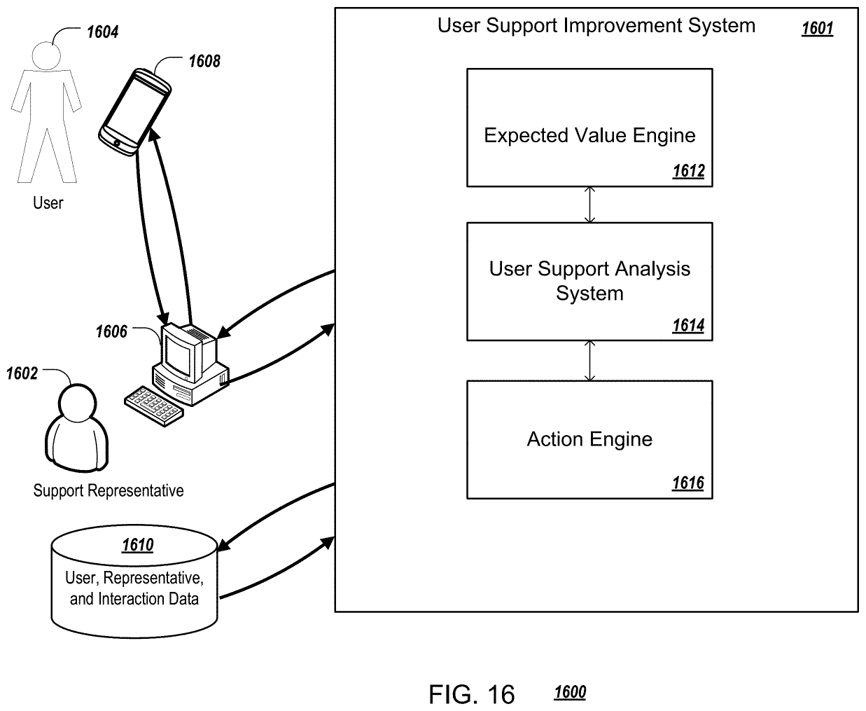

Further details and advantages of the analysis system are described below. For example, FIGS. 1-15 provide details regarding a workforce analytics manager for recording and managing interactions. FIGS. 16-19B provide additional details regarding retaining user value through user support interaction analytics generated by the analysis system.

The following detailed description describes techniques for discretizing time spent by users (e.g., customer service agents) doing specific tasks on computers. These technologies generally involve associating identifiers (IDs) from different systems while users spend time handling a case spanning multiple pages and applications of the different systems. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The techniques of the present disclosure can be used to assign each user action to a single “case” that a customer service agent is working on when the customer service agent is working simultaneously on more than one case. For example, the customer service agent can be a customer representative agent that handles Customer Relationship Management (CRM) cases that arrive at a CRM system by phone call, chat session, or online portal.

In some implementations, discretizing time can include setting identifier threshold rules, so as to define finer-grain criteria used to identify events that count as being associated with a case. Rules can also be used to define and access a set of identifiers used in set of systems that are to be tracked. Techniques of the present disclosure can be used to disregard time spent associated with identifiers that are not included in a tracked subset of systems to be tracked. Moreover, techniques of the present disclosure can be used to disregard identifiers corresponding to events that last less than a threshold event duration. Doing so can provide the benefit of avoiding an interruption of a current count of work being discretized.

Identifiers from multiple systems can be linked by observing an expected behavioral pattern of a user, such as a customer support agent. As an example, the system can determine that customer support agents generally follow a certain workflow on a given case. The identifiers used in the different systems that are accessed during the workflow can be linked together even if their linkage was previously unknown. For example, a chat application (or app) for chatting with customers may have a chat ID which is used as the case ID of the case. In a new chat, the customer support agent may use their own internal CRM system where they look up the customer. The internal CRM system may have a completely different set of identifiers, different from the chat app. If it is known that the customer support agent is always going to look up the customer in a certain amount of time after getting a new customer chat request, then the identifiers can be automatically associated or linked.

In some implementations, input context intervals (ICIs) can be used to improve the tracking of events in a more efficient way. An ICI is defined as a time interval having beginning and ending timestamps corresponding to a user action having a context (e.g., associated with a specific case). For example, events can be tracked by recording keystrokes. If the customer support agent is working on multiple cases at the same time, techniques of the present disclosure can be used to determine which case gets precedence. If a customer support agent is switching between systems, as noted above techniques of the present disclosure can link two systems that have their own case IDs but that are linked by the workflow. In order to be more efficient in linking cases and tracking time spent by customer support agents on each case, techniques of the present disclosure can be used to only allow one case to interrupt a second case if the duration of the interrupting event is above a threshold time. The threshold time can be a variable by specific situation and the system(s) that are involved. In computer systems that implement the techniques of the present disclosure, computer-implemented methods can be implemented for determining the primary task on which an agent is working when it appears that the agent is working on multiple simultaneous tasks. The computer-implemented methods can use configurable rules.

A browser in which the chat app executes can use an application programming interface (API) to send a data stream to a back end system for interpretation. APIs can be programmed to notice events that occur inside a browser or outside a browser. For example, a browser (e.g., Chrome) plugin can be implemented such that whenever an agent switches windows within a browser and visits a new page, the system records the event (e.g., the event data is sent to the backend system). A similar API can exist in Windows, for example, when an agent switches to a different window, sending event data to a server/backend. For example, the event data can indicate that the agent spent a specified amount of time on web site V, or the agent spent a specified amount of time in application window X with page title Y.

In some implementations, ICIs can be implemented through the use of recording timestamps instead of just recording a time duration. In this way, the timestamps can additionally be used to correct durations corresponding to the start and end times spent on a webpage by a customer support agent. As an example, the timestamps can be fitted to key strokes that occur when a customer support agent is on a particular web page.

FIG. 1A shows an example of a workforce analytics system 100 that can be used to determine discrete time spent by customer service agents on different tasks across different systems and produce reports based on discretized time, according to some implementations of the present disclosure. The workforce analytics system 100 includes a workforce analytics manager 102 that interfaces with one or more customer relationship systems 104. Each customer relationship system 104 includes one or more customer relationship applications 106, such as CRM systems. Users (such as CRM agents) can use the customer relationship system 104, for example, by accessing webpages 108 and using desktop applications 110.

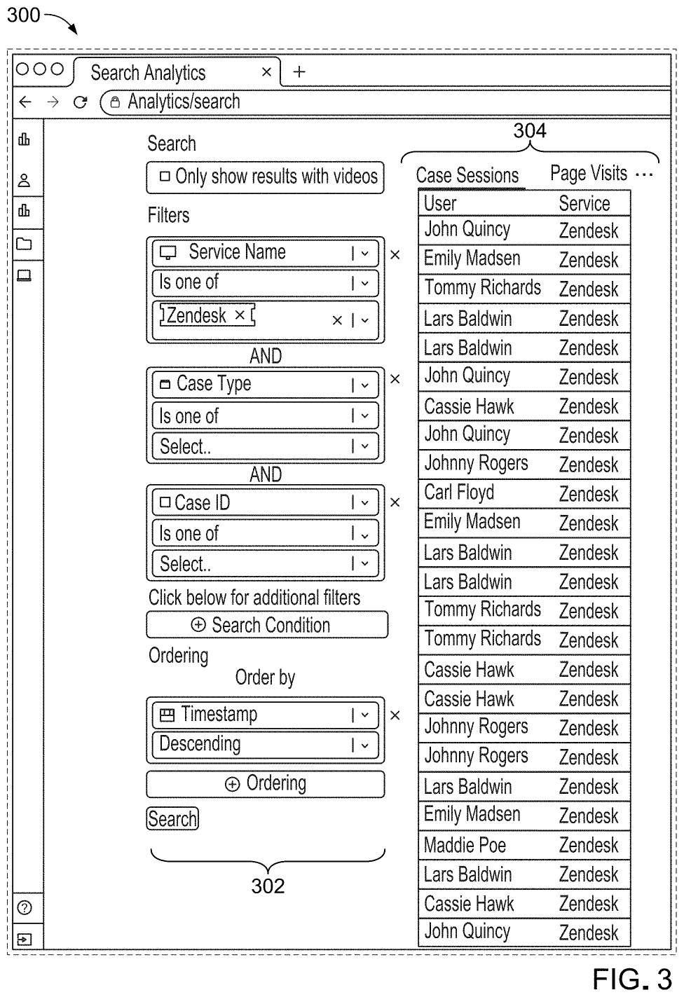

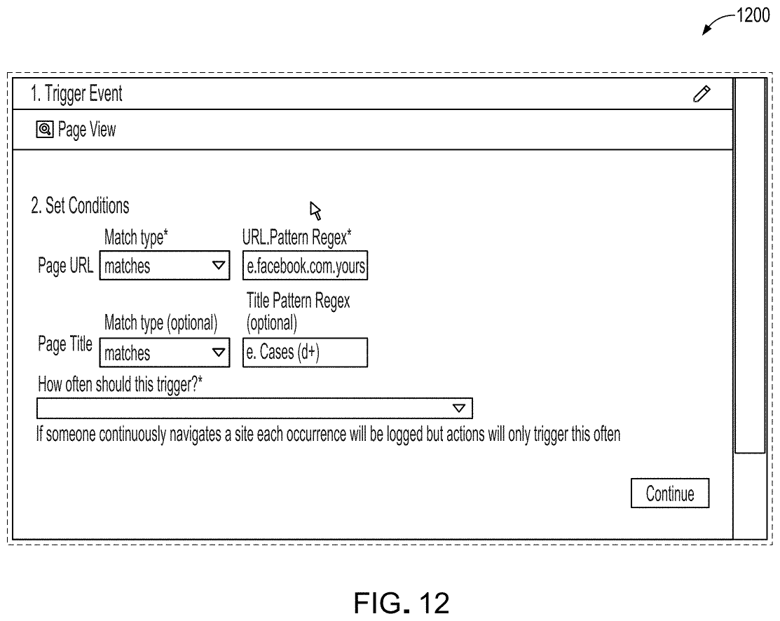

While an agent is using the customer relationship systems 104, a data stream 112 is sent to the workforce analytics manager 102 for interpretation. The data stream 112 can include discretized time data captured by browsers using APIs to send the data stream to a back end for analysis. The workforce analytics manager 102 can store the received data stream 112 as analytics data 116. The workforce analytics manager 102 can use the analytics data 116 to generate reports. The report can include, for example, reports containing information described with reference to FIGS. 3-11. Techniques by which the data stream 112 captures data include parameters and set-up operations described with reference to FIGS. 12-14C. Components of the workforce analytics system 100 are connected using a network 114 that includes, for example, combinations of the Internet, one or more wide area networks (WANs), and one or more local area networks (LANs).

Examples of reports that can be produced using discretized time data can include focus events. Focus events can be used, for example, to assign each action performed by an agent to a single “case.” An action that is assigned to a case can be disambiguated from actions performed on other cases. Discretizing the time and assigning events to specific cases can be based on cross-platform tagging for each active session. Automatic matching can occur, for example, when an agent opens a specific document within a specific period of time after opening a case. The automatic matching can use agent behavior pattern recognition that incorporates logic for timeouts, accesses to specific pages and documents, and automatic linking of identifiers from disparate systems.

The workforce analytics system 100 can perform tracking in the context of multiple workflows and multiple customers. For example, a customer service agent may have a workflow to provide a customer refund that requires the customer service agent to access a number of different systems. Based on a list or pattern of the different systems necessary for a particular type of task, workforce analytics system 100 can insure that the customer service agent follows a proper procedure while collecting metadata from each system that the customer service agent accesses and linking the metadata together.

A customer service agent may be handling multiple, simultaneously customer service cases (for example, chats) at once. Even though the time is overlapping for each of the associated customers, the workforce analytics system 100 can determine how much of their time is actually spent on each customer. The time that is tracked includes not only how much time the customer service agent is chatting with that customer, but how much time the customer service agent is spending working on that customer versus working on actions associated with another customer. The workforce analytics system 100 can use clustering algorithms and other techniques to identify that an agent is working on the same case across different systems. The clustering can occur, for example, using text copied from one box into another and based on patterns of access of different systems when handling a case.

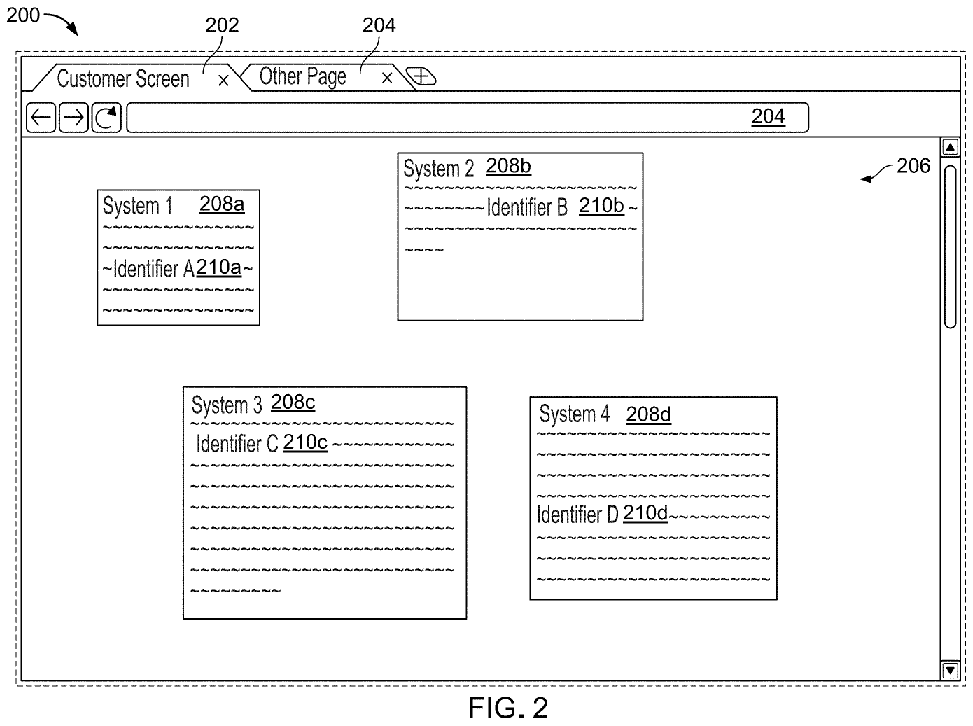

FIG. 1B shows an example of the workforce analytics manager (WAM) 102 of FIG. 1A, according to some implementations of the present disclosure. The WAM 102 includes a WAM front end 152 that provides a user interface for a user to request reports 154, for example, using analytics data 156. The analytics data 156 can include data described with reference to FIGS. 2-9. Report requests 154 can be made by a user through a web user interface (UI). Example reports can include viewing true utilization and viewing true handle time. Using the UI, the user can apply filters, including user filters and date filters (e.g., date range=last week). The analytics data 156, including user actions and event data, can serve as data input to a query engine 158 accessible through the UI for accessing relevant data for requested insights. Calculated insights 160 can be used to display report insights 162. For example, for a report providing true utilization (including user efficiency and time spent on cases), the insights can be used to create a ratio of hours active on cases and hours ready for work. Displayed reports can be displayed, for example, as table results, bar graphs, pie charts, and flow charts. Example reports are described with reference to FIGS. 2-10B.

FIG. 2 is a screenshot 200 of a customer screen 202 for handling cases in the workforce analytics system 100, according to some implementations of the present disclosure. The customer screen 202 can be an interface used by a user (for example, a customer service agent). The customer screen 202 can be one of many screens available and used in the user's browser or on the user's desktop to handle cases, including another page 204 that may present a user interface for specific products or services. An originating call, such as a chat, may originate on the customer screen 202 used by an agent. The agent may immediately or subsequently navigate to other resources, such as other pages 204, to look up the customer or perform some other action related to the case.

Working areas 206 in customer screens 202 and other pages 204 can include several pages 208a-208d (or specific screens), accessible through browsers, for example, each with corresponding identifiers 210a-210d. Other resources accessed by the customer service agent can include documents such as word documents and spreadsheets for presenting and recording information associated with a case. The identifiers 210a-210d may be completely different across the systems associated with the pages 208a-208d. However, the workforce analytics system 100 can use the analytics data 116 to associate an identifier with work done on various uncoordinated systems, which in turn can link together time spent on those different systems for the same case. The various uncoordinated systems can provide multiple software services such as web pages, documents, spreadsheets, workflows, desktop applications, and conversations on communication devices. The multiple software services include at least a software service of a first type and a software service of a second type, where the software service of the first type and the software service of the second type are uncoordinated software services lacking inter-service communication and a common identification labelling system.

In some implementations, the following steps can be used for assigning an event to a case. First, the system determines a location of a case ID or other identifier. For example, the identifier may only be seen on webpages matching specific Uniform Resource Locator (URL) patterns or using specific desktop apps. Such identifiers can be extracted from the URL, from a page/app title, or from a specific region in the HTML hierarchy of the webpage.

Each website or desktop app where an ID can be extracted is known as a service. By associating observed identifiers together with multiple services, events from multiple services can be associated together under a single case ID. The case ID can originate from whichever service the system determines to be the primary service.

To associate a first identifier with a second identifier, a sequence of events can be defined that represents the observation of identifiers in a particular order, within a bounded time-frame. The system can use this defined sequence of events to link events and their respective identifiers. Such a defined sequence can be a sequence of pages, for example, that are always, or nearly always, visited, in order and in a time pattern, when a new case is originated and handled by a customer service agent. Whenever a linked identifier is determined, that event and any subsequent events are associated with the case as identified by the identifier from the primary service.

In a working example, consider a customer service agent that engages in multiple simultaneous chats and uses a separate CRM service to look up customers and make changes to their accounts. Since the customer service agent switches between the chat windows and the CRM service, there is a need to know, specifically, how much time is spent on each customer and case. The following sequence of events can be defined.

First, the customer service agent receives a new chat box, for example, entitled “Chat 123” on a website that is considered as the primary service. The new Chat ID 123 is created, and the Case ID is marked with the Chat ID. Second, within a threshold time period (e.g., 60 seconds), the customer service agent searches the CRM system for the customer.

Third, within another 60 seconds, the customer service agent lands on the customer's page within the CRM that matches the URL pattern (for example, crm.site.com/customers/234). The CRM ID 234 is recognized, and the ID 234 is linked with Case ID 123.

Fourth, the customer service agent responds to another customer and enters a chat box, for example, with Chat ID 567. This action and subsequent actions in this chat box are not associated events with Chat 123, but instead are associated with Chat 567.

Fifth, the customer service agent goes back to the CRM system on page crm.site.com/customers/234. This surfaces CRM 234 which is linked with Chat 123, associating that event and subsequent events with case 123 until the next time case 123 is interrupted.

Note that, if the customer service agent performs other events at the same time as the sequence of events described above, such additional events do not affect the system's ability to recognize system operation. This is because certain implementations do not require that the set of events is exclusively limited to the chat and CRM events noted above.

In some implementations, the functionality of the techniques of the present disclosure can be represented in pseudocode. Assume that event stream is a variable that represents a time-ordered list of the following types of events: 1) webpage visits with URLs and page titles, 2) desktop application window events with page titles, and 3) clicks, events, and interactions within a web page on a particular webpage element or region that has its own descriptors. A case ID can be defined as any identifier associated with a service that is the primary tool used for customer communications. In such a case, pseudocode describing operation of the workforce analytics manager of FIG. 1A can include:

```
identifier_mappings = <Mapping of Case ID to list of linked identifiers>
all_possible_sequences = <List of event sequences already in process for
each rules
pertaining to possible sequences of events>
current_case_id = None
for event in event_stream:
  for current_sequence_step in all_possible_sequences:
    if current_sequence_step.matches(event):
      identifiers = current_sequence_step.get_identifiers(
        event.page_title,
        event.url,
        event.html
      )
      current_sequence_step. move_to_next_step( )
      current_case_id = current_sequence_step.get_case_id( )
      # If current_case_id cannot be resolved this way look
      # for a mapping
      If not current_case_id:
        current_case_id = [
        key for (key, existing_identifiers) in identifier_mappings
        if identifiers intersects existing_identifiers
        ]
      if current_case_id:
      identifier_mappings[current_case_id].append(identifiers)
  event.case_id = current_case_id (attribute event to Case ID)
```

At a high level, the pseudocode links events (e.g., customer service agent actions) to corresponding cases and captures event information (e.g., clicks, customer service agent inputs) for the events, e.g., by stepping through a sequence of events that have occurred. Once the system has analyzed agent events and assigned those events to various cases, the system can provide a variety of useful functions. For example, FIG. 3 is a screen shot of an example of a search analytics page 300 for looking up customer service agent events, according to some implementations of the present disclosure. The search analytics page 300 includes search controls that facilitate searching for particular types of customer service agent data, for example, for actions and events by one or more specific customer service agents. The filters can be used to select customer service agent events by combinations of customer service agent name, case type, and case ID. Sorting controls can allow a user of the search analytics page 300 to sort the output of filtered information in different ways.

The search analytics page 300 displays data stream information that can be collected to identify how customer service agents are spending their time on particular cases. The information that is displayed can include case type (for example, printer fires) or specific application (for example, ZENDESK).

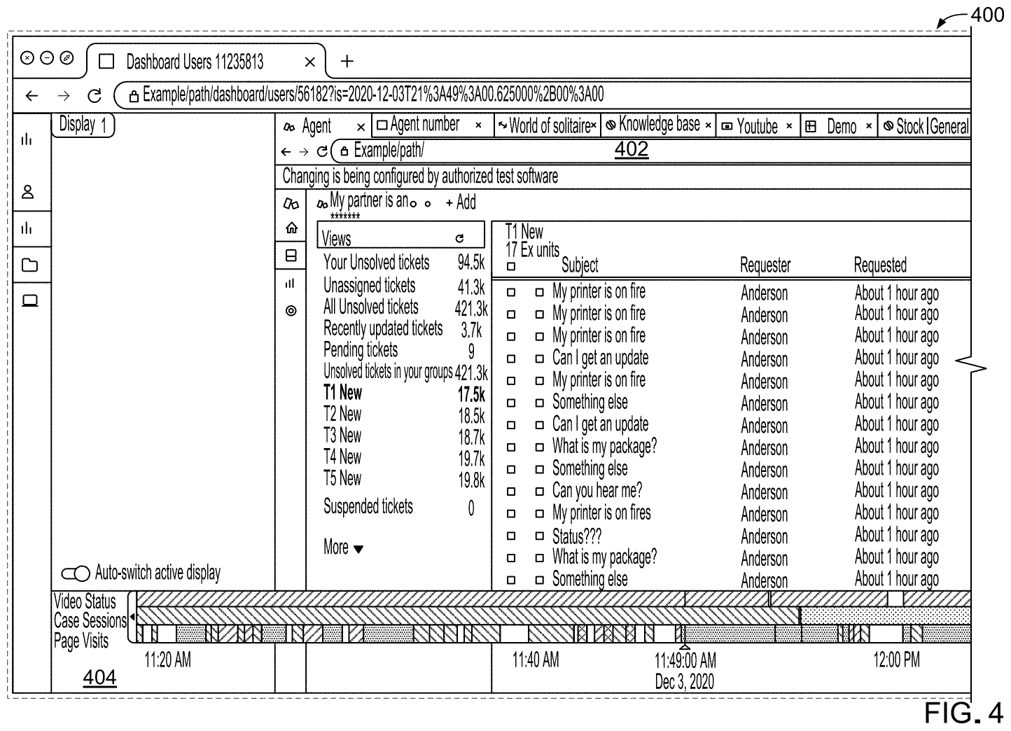

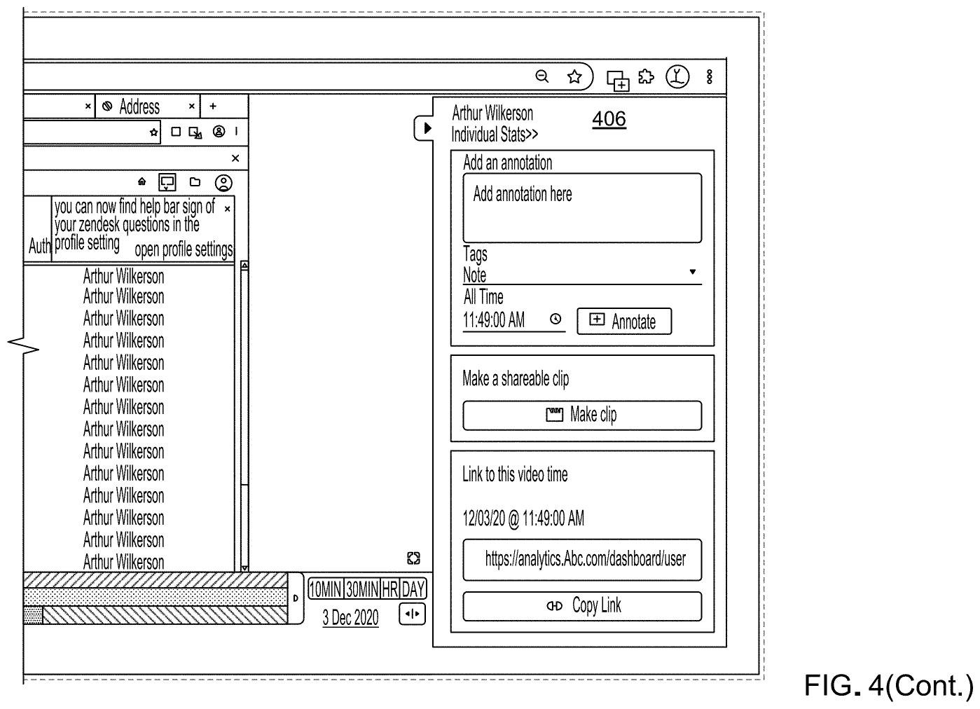

FIG. 4 is a screen shot of an example of a dashboard 400 for customer service agent time spent on cases, according to some implementations of the present disclosure. A cases information area 402 can list different cases, each case's case type (e.g., “My printer is on fire”), and other information for each case.

A video playback area 404 can allow the user of the dashboard 400 to open a video corresponding to focus events for a particular case. The case session video playback area 404 can include a video status bar, a case sessions bar, and a page visits bar. Each bar is displayed relative to time, for example, from opening a case until handling of the case is complete.

A video status bar in the dashboard 400 can allow the user to display a video of what has occurred on overlapping cases. For example, playing the video in high speed can show the overlapping case sessions on which a customer service agent has worked. The video can show, for example, that the customer service agent was working on case X, then looking at a different case, then working on case X again.

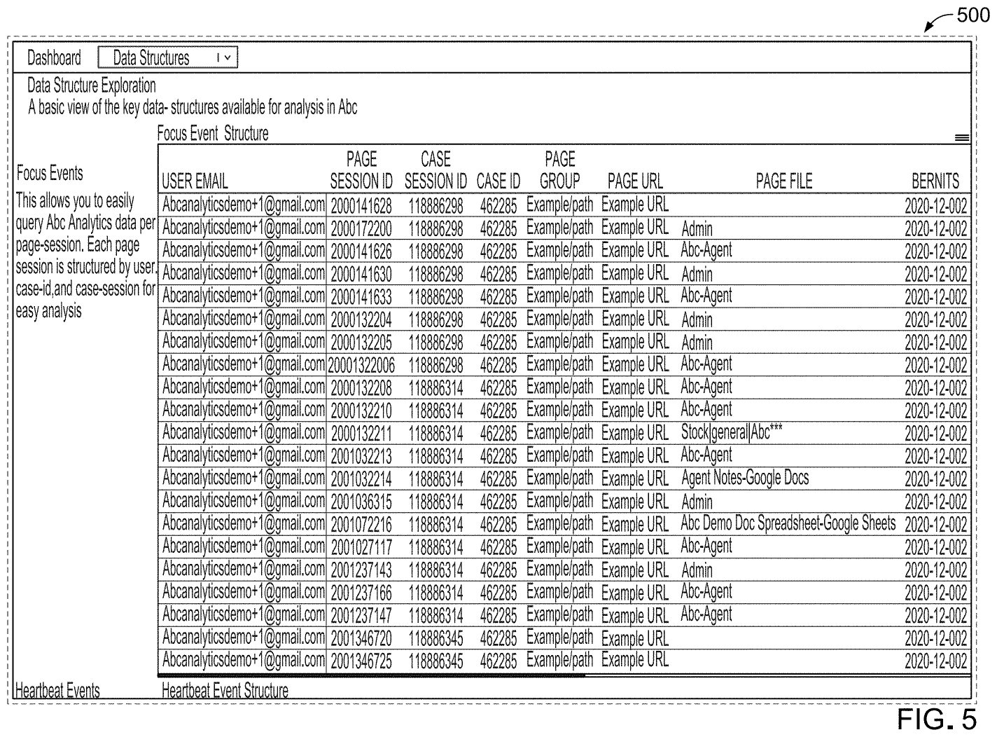

FIG. 5 is a screen shot of an example of a focus events structure 500, according to some implementations of the present disclosure. The focus events structure 500 can be used to capture and store information about page events. This can include information such as every single time the customer service agent switches pages or looks at a new resource, what case is associated, and which case session? The information can include multiple case sessions, the working customer service agent, how much time was spent, page refreshes, key presses, paste actions, and mouse scrolls.

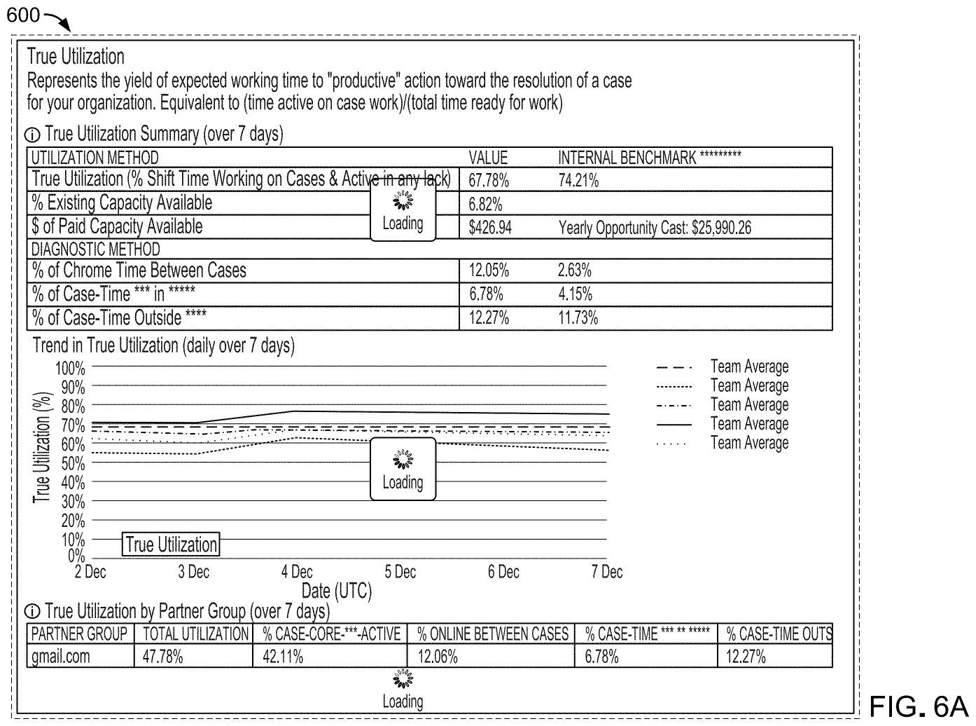

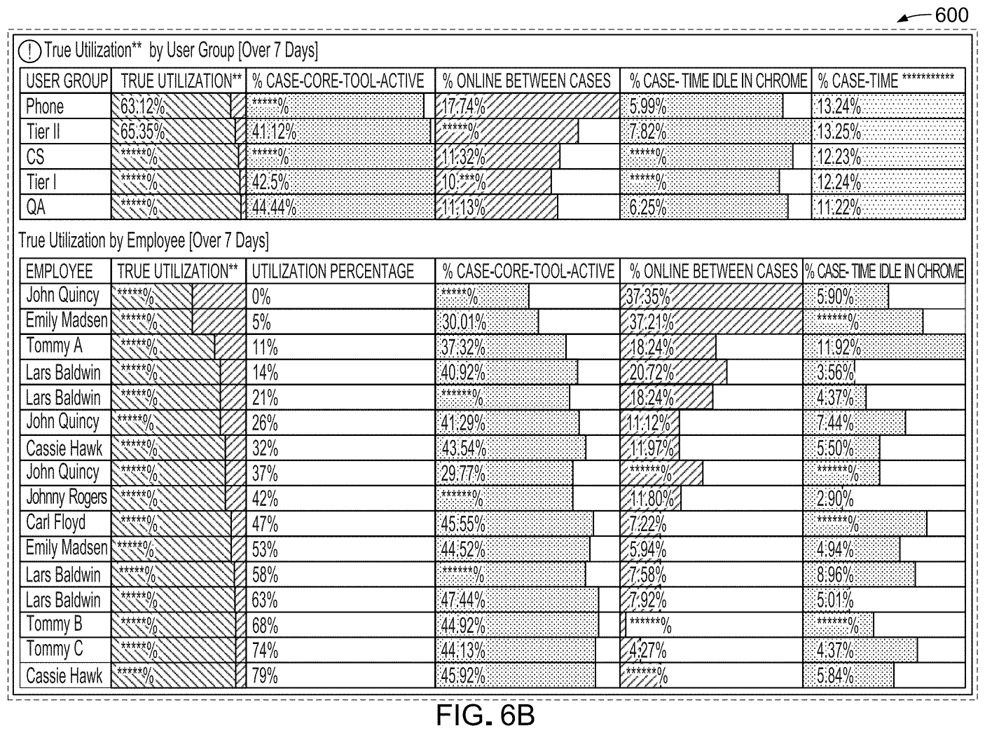

FIGS. 6A-6B are screen shots collectively showing an example of a true utilization page 600, according to some implementations of the present disclosure. The information includes heartbeats indicating, for every 60 seconds, how the CPU is performing, whether the customer service agent was active, page load events, page load times, open tabs, and slow times.

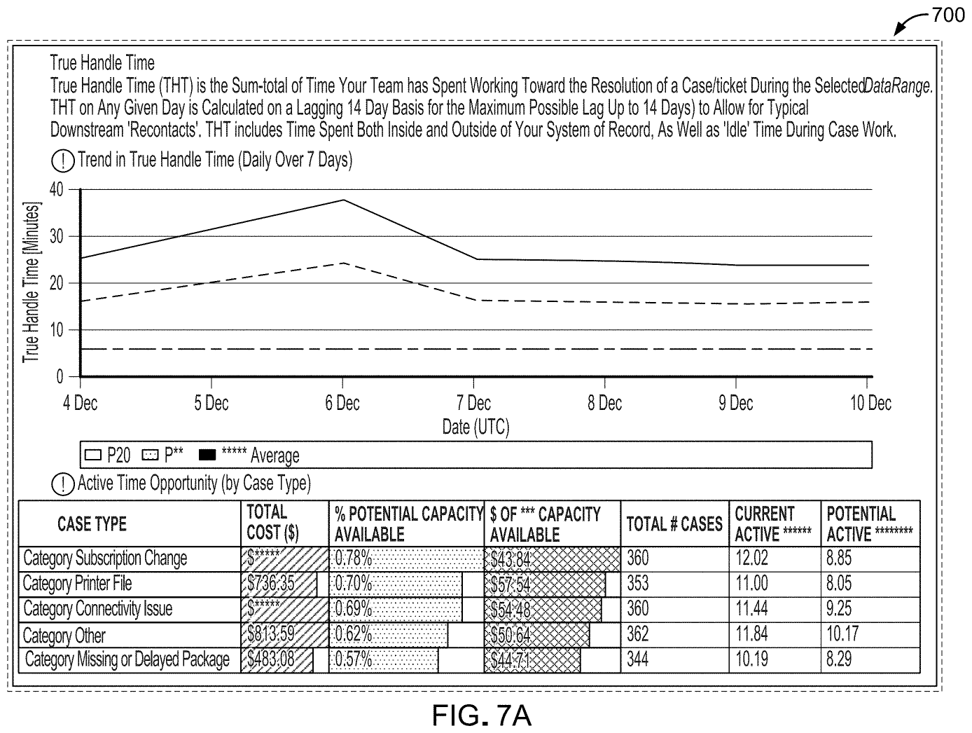

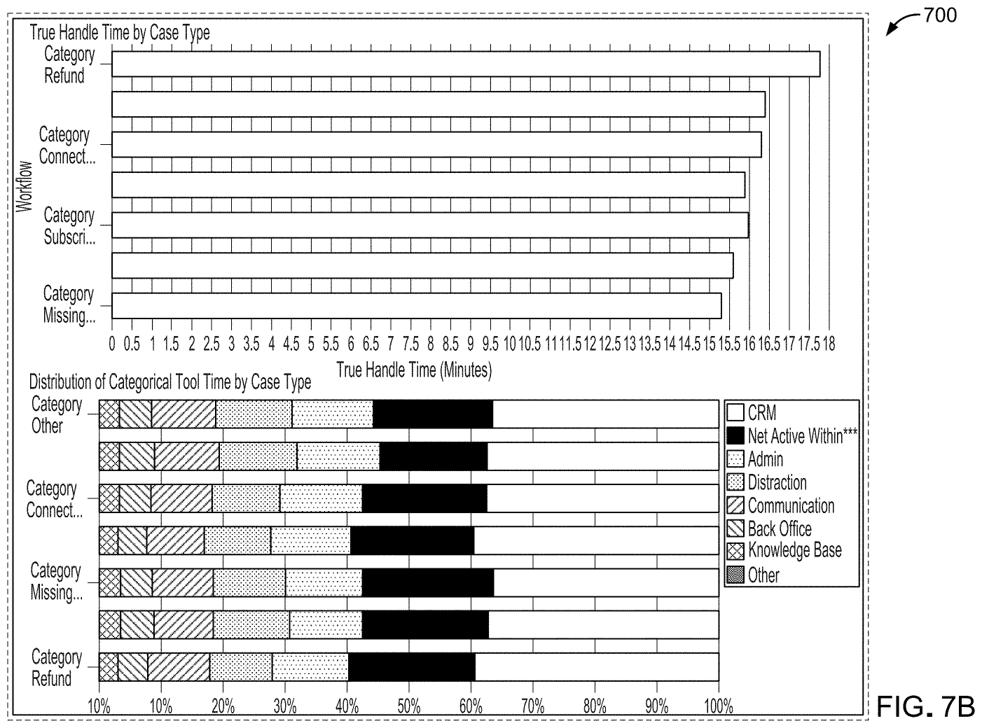

FIGS. 7A-7B are screen shots collectively showing an example of a true handle time page 700, according to some implementations of the present disclosure.

The system uses a Document Object Model (DOM) to monitor clicks, scrolls, and actual IDs of objects accessed, down to the class names. The DOM is a cross-platform and language-independent interface that treats an XML or HTML document as a tree structure, where each node is an object representing a part of the document. The DOM represents a document with a logical tree. Each branch of the tree ends in a node, and each node contains objects. DOM methods allow programmatic access to the tree. Nodes can have event handlers attached to them. Once an event is triggered, the event handlers are executed. The DOM information provides tracking of clicks, and the workflow analytics system can attach the tracked clicks and active page events to a corresponding case. This connection of clicks and active page events to a specified case can be used to understand, for each customer service agent, how active they are, and what opportunities exist for improving true handle times for a particular customer service agent.

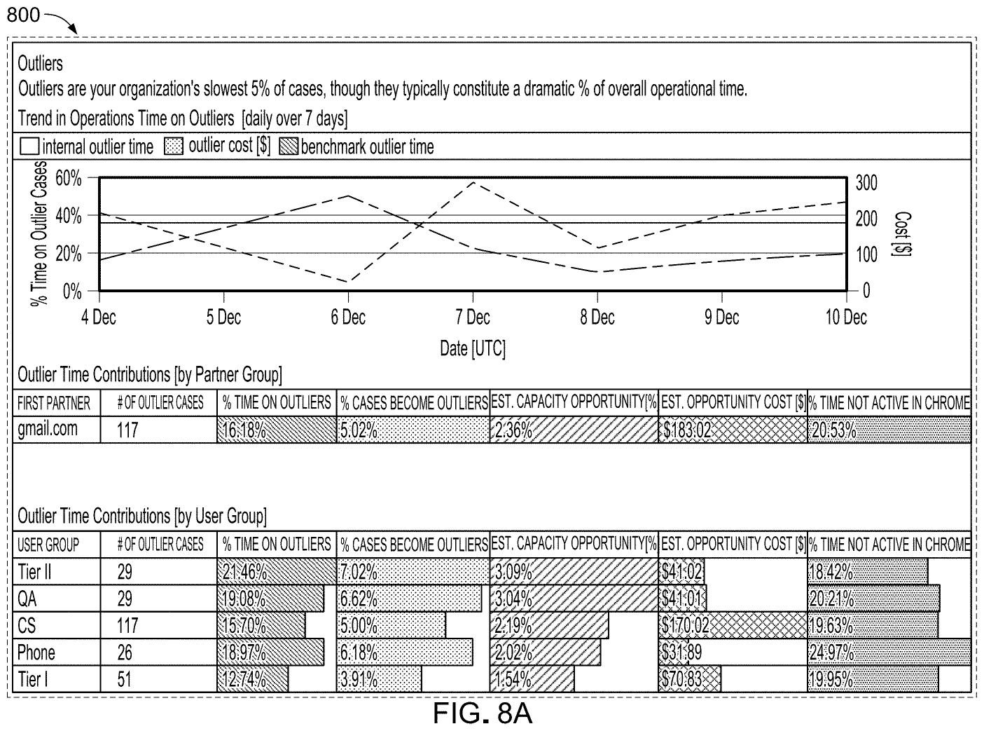

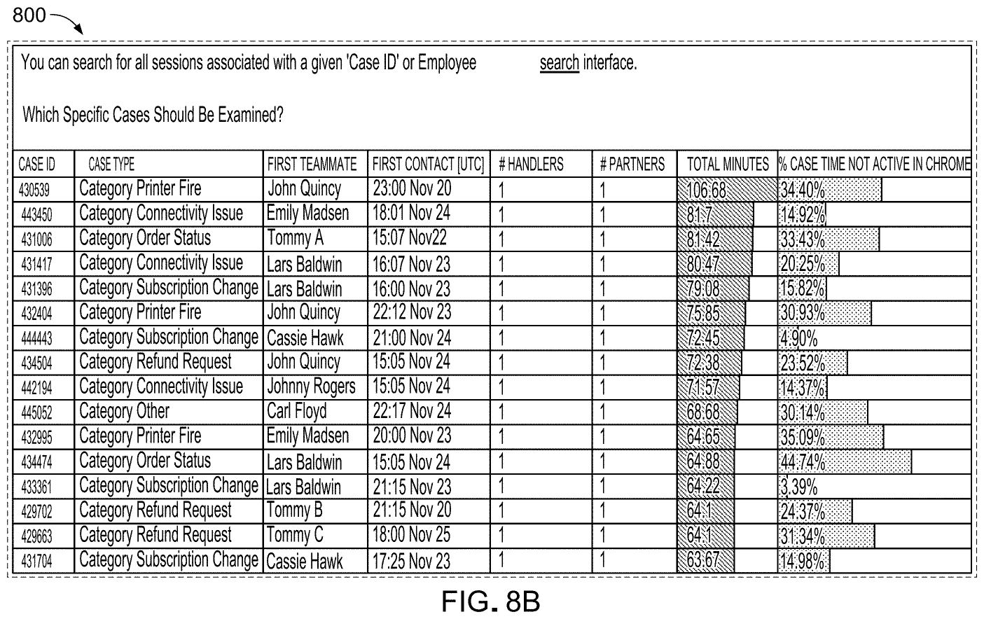

FIGS. 8A-8B are screen shots collectively showing an example of an outliers page 800, according to some implementations of the present disclosure. The outliers can identify the cases that are taking the longest.

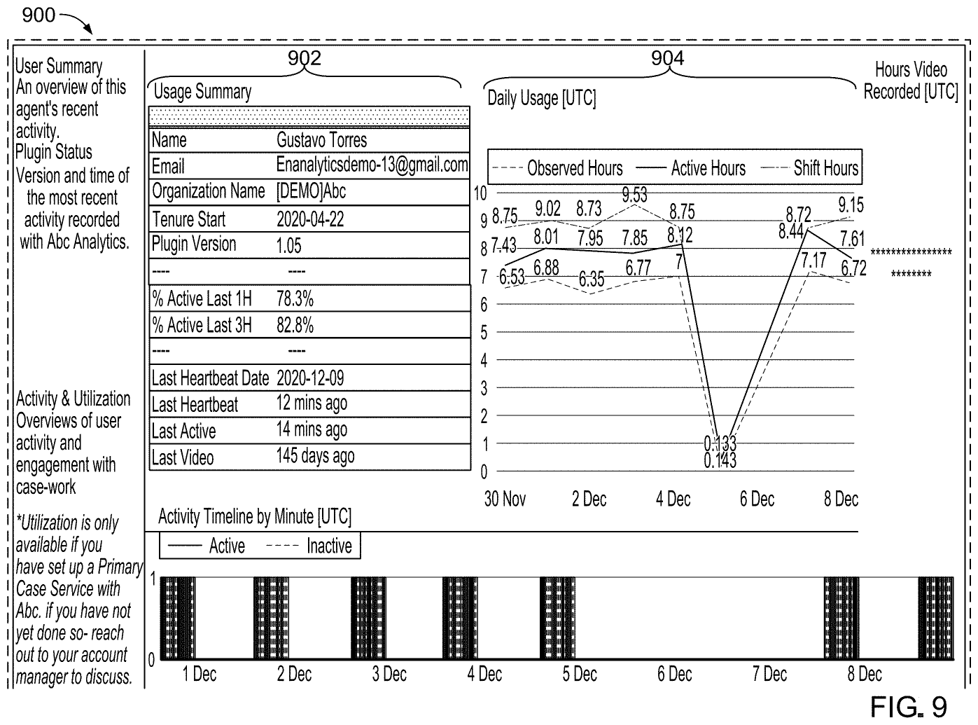

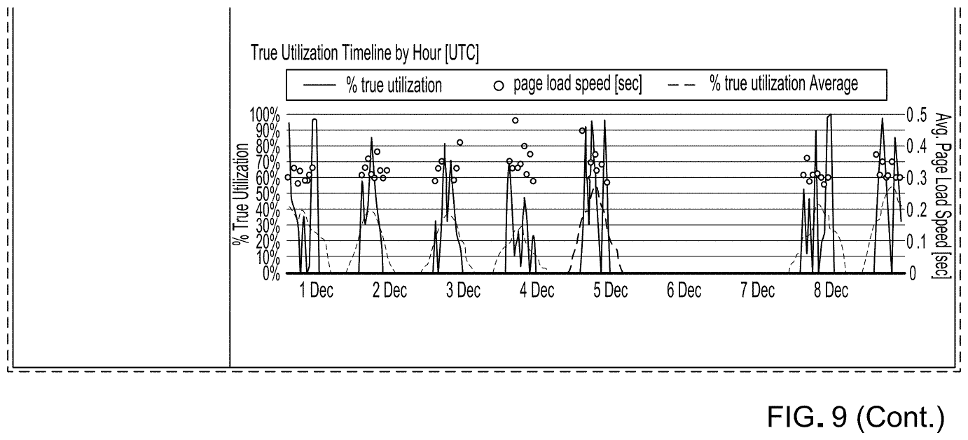

FIG. 9 is a screen shot of an example of a customer service agent summary page 900, according to some implementations of the present disclosure. The customer service agent summary page 900 includes a customer service agent summary area 902 that provides customer service agent profile information and productivity statistics for a customer service agent. A daily usage area 904 includes graphs showing customer service agent activity statistics (e.g., in hours) over time, identifying customer service agent shift hours, observed hours, and active hours.

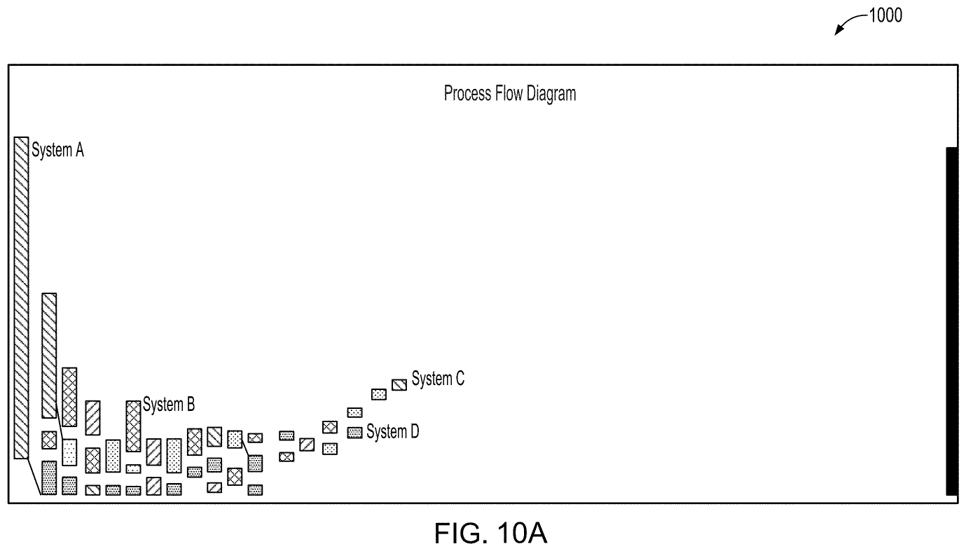

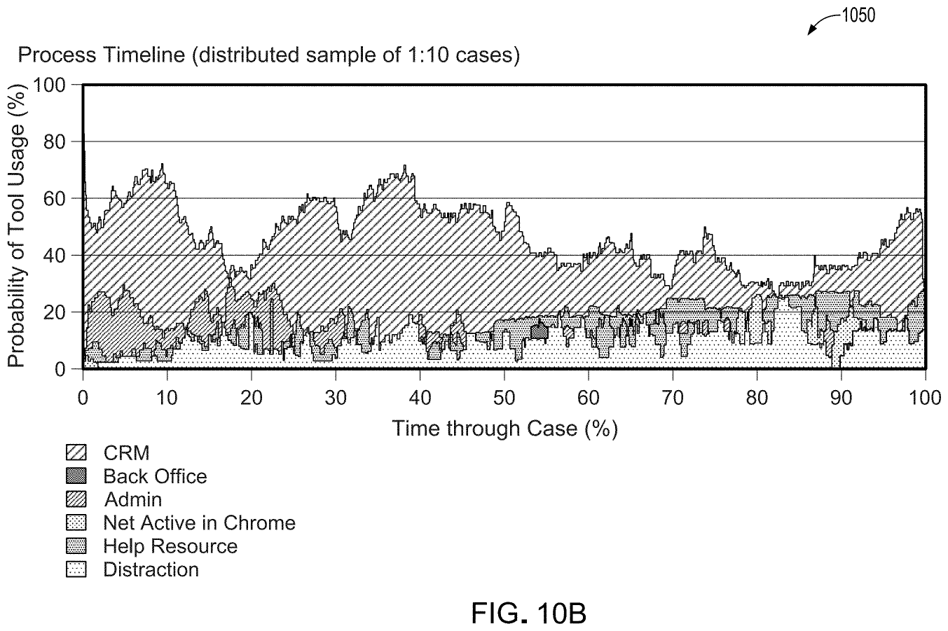

FIG. 10A is a screen shot of an example of a process flow diagram 1000, according to some implementations of the present disclosure. The diagram shows the most likely path to close a ticket based on active page events. Blocks in the diagram are arranged over time and indicate a progression of systems used by the customer service agent to work on the ticket. The blocks can be annotated with one or more of descriptive labels, shading, and color, for example, to indicate that the ticket started in CRM, moved to an administration (admin) tool, and then back to CRM.

FIG. 10B is a screen shot of an example of a process timeline 1050, according to some implementations of the present disclosure. The timeline can show the resources that were used and which ones were used a higher percentage of the time. This can identify where customer service agents are getting stuck and what is likely their next step.

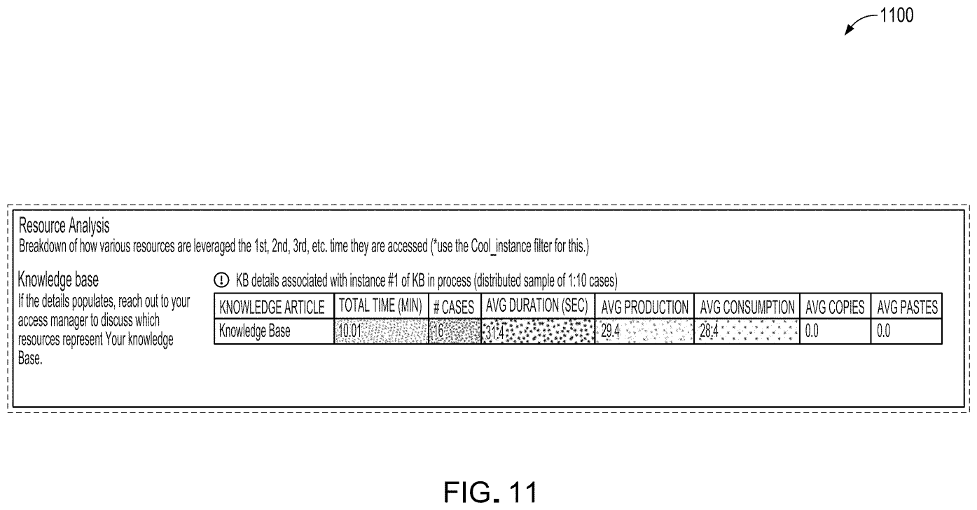

FIG. 11 is a screen shot of an example of a resource analysis page 1100, according to some implementations of the present disclosure.

FIG. 12 is a screen shot of an example of a trigger event definition page 1200, according to some implementations of the present disclosure. Trigger events effectively provide the ability to parse pages visited by a customer service agent while working on a given case. A trigger event can be used to parse the URL, for example, when a page matches XYZ, to extract the case ID out of it. This information can be used to identify how a new case is started. For example, a trigger condition can be set when the URL of a page (e.g., viewed by the customer service agent) matches a particular URL pattern, or when the title of the page matches a particular title pattern. Conditions defined on the trigger event definition page 1200 can be defined using Boolean operators for matches of URLS, titles, and HTML elements found on the page.

As an example, a trigger event can be defined for triggering a new case (or being associated with a current case) when a customer service agent navigates to a web page such as page 208a, having a specific URL. The page 208a can correspond to the first block in FIG. 10A, for example. Using defined trigger events a sequence of events can be tracked that occur in multiple software services being accessed by a customer service agent. The sequence of events can include one or more events from each case of a group of cases handled by the customer service agent. Using information extracted from one or more interactions of the customer service agent with at least one service, focus events can be determined that identify which case in the group of cases is being worked on by the customer service agent at various points in time, with each focus event having a focus event duration. Each focus event can be assigned to a particular case using the extracted information. A total period of time spent by the customer service agent on the particular case can be determined based on a sum of focus events durations for the focus events assigned to the particular case.

In an example, when a trigger (e.g., a page view) occurs, additional controls that are available from the trigger event definition page 1200 can be used to define certain responses that are to happen (or be triggered, in addition to logging the event). The responses can include, for example, creating an activity (e.g., marking this moment, or timestamp, in time), sending an email, sending a workbook, providing a Chrome notification, or redacting video. Marking the moment can cause the moment to be labeled on the timeline of the video playback area 404, for example.

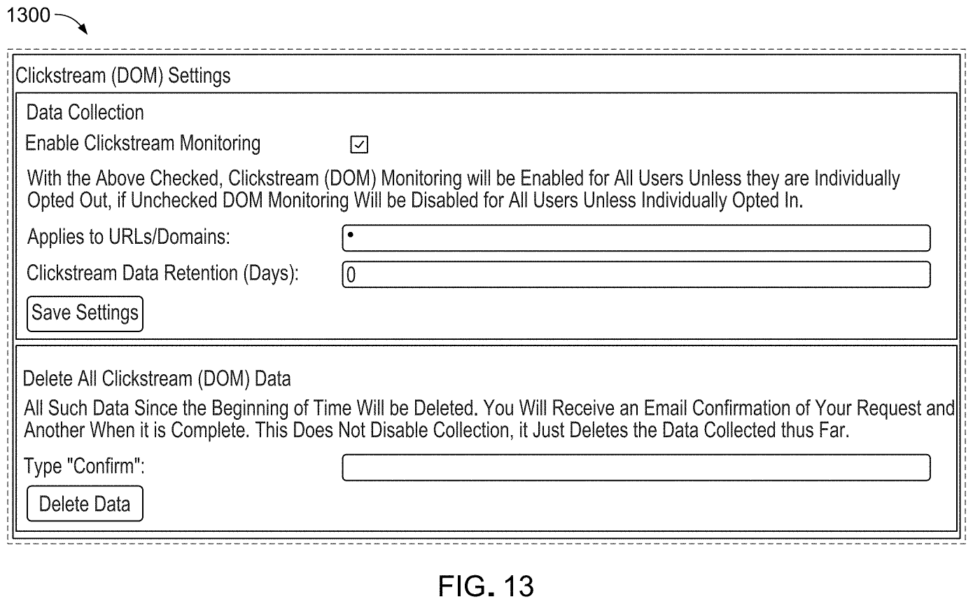

FIG. 13 is a screen shot of an example of a clickstream page 1300, according to some implementations of the present disclosure. The clickstream page 1300 can be used to identify specific data that is to be monitored and collected. Monitoring performed by the clickstream page 1300 can be filtered or limited based on opt-in and opt-out preferences set for specific customer service agents. Settings in the clickstream page 1300 can be used to define specific pages (e.g., by URL) that are to be used in monitoring and to specify a data retention time (e.g., a number of days) for monitored information. Clickstream deletion time fields can be used to control when existing clickstream data is to be deleted.

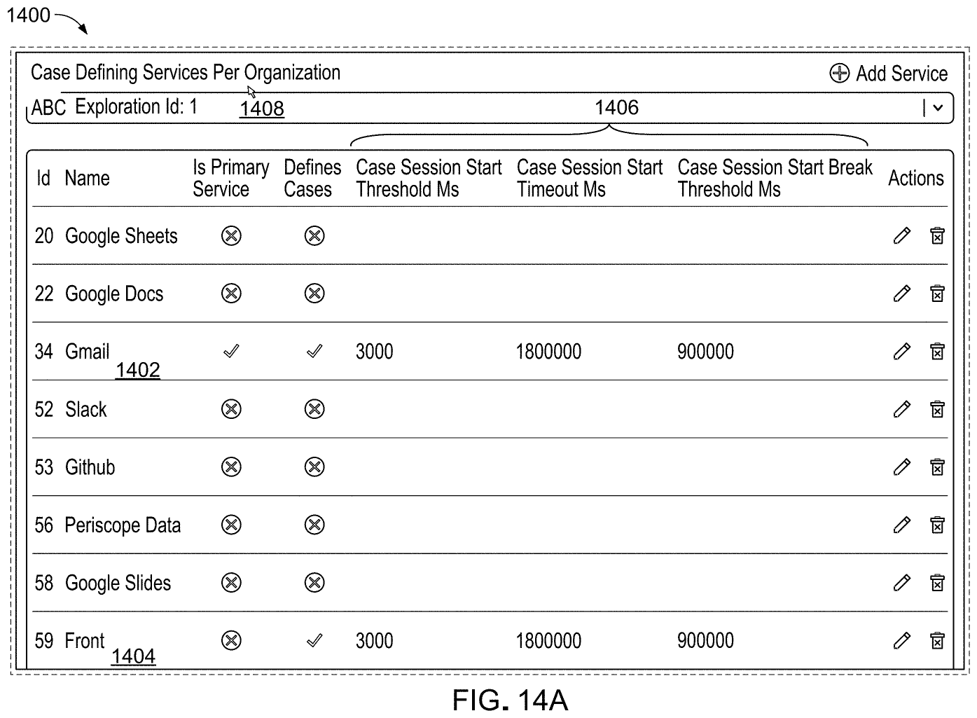

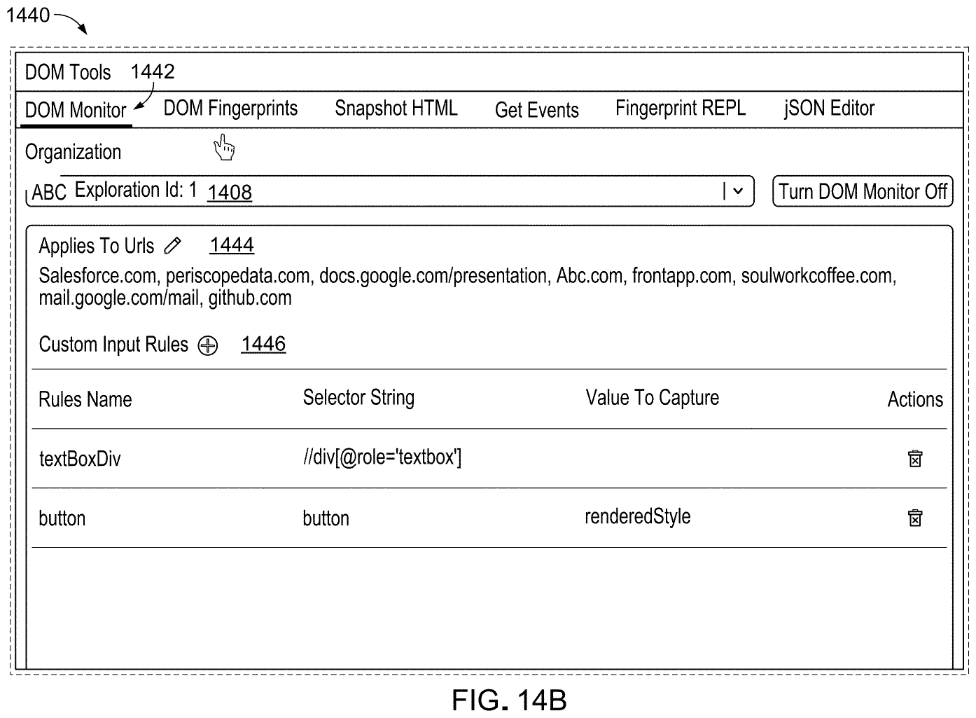

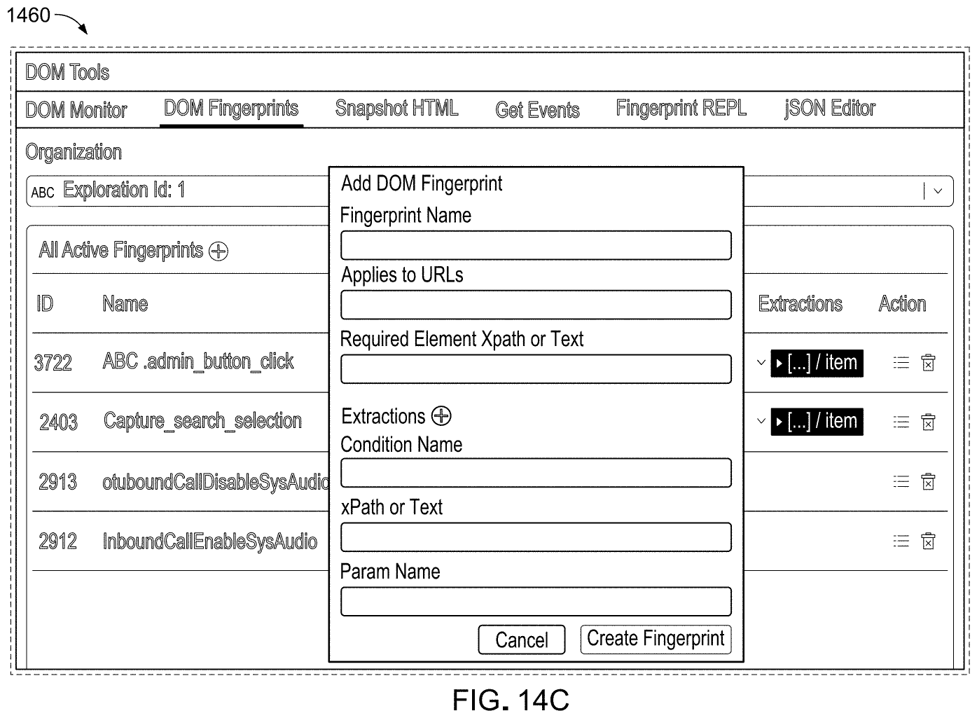

FIG. 14A is a screen shot of an example of a case defining services per organization page 1400, according to some implementations of the present disclosure. The page 1400 allows a user (such as an Administrator of agent monitoring) to identify which services apply to an organization's cases. The definitions identify the names of services and time thresholds (e.g., start, timeout, and break times) that are used to link customer service agent actions to a case. For example, for the case currently defined on the page 1400, fields of the page define a Gmail app 1402 and a Front app 1404, with time thresholds 1406, as being the apps used for cases in Organization ABC 1408. The start time indicates a minimum time that a case is in view before the case is considered being worked on by the customer support agent. Doing this avoids assigning time to a case when the customer support agent tabs through information for the case for only a moment.

FIG. 14B is a screen shot showing an example of a DOM tools page 1440, according to some implementations of the present disclosure. For a currently-selected DOM monitor option 1442, a URLs list 1444 identifies the current list of URLs that DOM settings apply to for the organization 1408. A rules section 1446 facilitates the definition of rules associated with DOM monitoring, including write a rule, for example, that defines a path of an element that starts or ends a specific case.

FIG. 14C is a screen shot showing an example of an add DOM fingerprint page 1460, according to some implementations of the present disclosure. The DOM fingerprint page provides the ability to define a fingerprint that effectively captures the path of an element effectively starting and/or ending a specific case. The fingerprint can apply, for example, to a key press, entry in a field, starting a recording, or some other action.

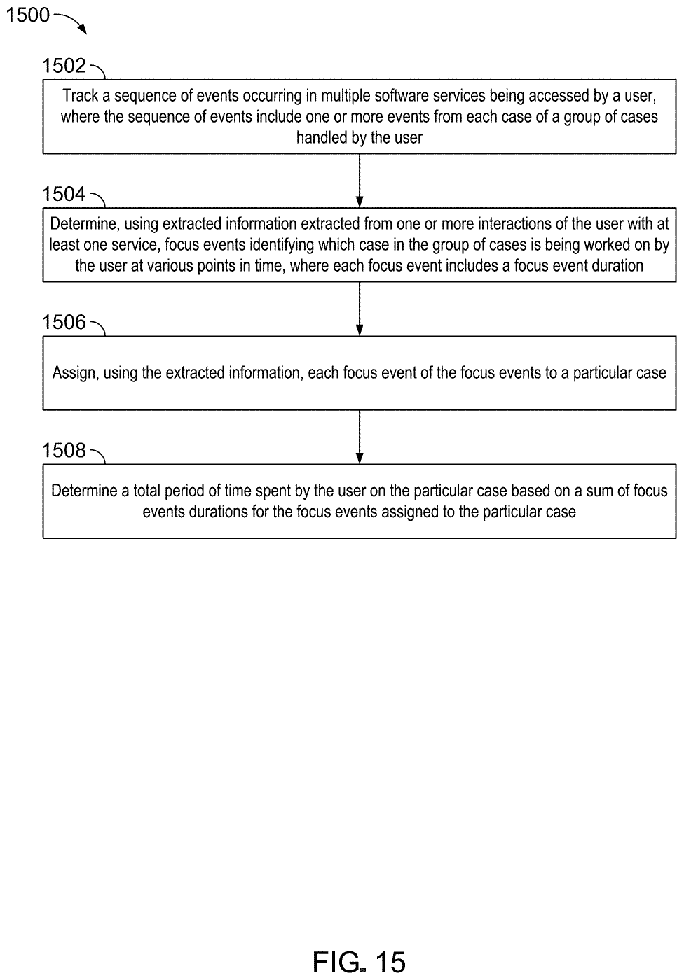

FIG. 15 is a flowchart of an example of a method 1500 for determining time spent by the customer service agent on the particular case, according to some implementations of the present disclosure. For example, the system 200 can be used to perform the method 1500. For clarity of presentation, the description that follows generally describes method 1500 in the context of the other figures in this description. However, it will be understood that method 1500 can be performed, for example, by any suitable system, environment, software, and hardware, or a combination of systems, environments, software, and hardware, as appropriate. In some implementations, various steps of method 1500 can be run in parallel, in combination, in loops, or in any order.

At 1502, a sequence of events occurring in multiple software services being accessed by a user (e.g., a customer service agent) is tracked. The multiple software services can include web pages, documents, spreadsheets, workflows, desktop applications, and conversations on communication devices. As an example, the multiple software services can include web pages used by the user within a CRM system, and the user can be a customer service representative. The sequence of events includes one or more events from each case of a group of cases handled by the user. For example, tracking the sequence of events can include the following. In some implementations, the multiple software services can include at least a software service of a first type and a software service of a second type, where the first type is CRM software and the second type is a search engine.

Focus events are recorded that identify page switches by the customer service agent, views of a new resource by the customer service agent, where each focus event identifies the customer service agent, an associated case, an associated session, a time spent on a particular page, whether the particular page was refreshed, keys that were pressed, copy-paste actions that were taken, and mouse scrolls that occurred. Heartbeats are recorded at a threshold heartbeat interval (for example, once every 60 seconds). The heartbeats can indicate CPU performance and whether the customer service agent has been active (and to what degree). Page load events are recorded including identifying a time to process a page load request, a time to finish loading the page, a number of tabs that are open, and whether a page load was slow. DOM events are recorded, including clicks by the customer service agent, scrolling by the customer service agent, an identifier of a software service, a class name and a subclass name of the software service, and content of text typed into the software service.

In some implementations, tracking the sequence of events can include setting identifier threshold rules defining a set of identifiers used in a set of systems that are to be tracked, disregarding identifiers not included in a tracked subset of the multiple software services, recording timestamps for start and end times on a particular software service, and disregarding, using the start and end times, identifiers corresponding to events that last less than a threshold event duration.

In some implementations, tracking the sequence of events can include collecting active page events, page level events, machine heartbeats, DOM events, video, audio, times when the customer service agent is speaking versus not speaking, times when the customer service agent is using video, entries written to documents, desktop application events, and entries extracted from the documents. From 1502, method 1500 proceeds to 1504.

At 1504, focus events identifying which case in the group of cases is being worked on by the customer service agent at various points in time are determined using information extracted from one or more interactions of the customer service agent with at least one service, where each focus event includes a focus event duration. From 1504, method 1500 proceeds to 1506.

At 1506, each focus event of the focus events is assigned to a particular case using the extracted information. For example, assigning each focus event of the focus events to a particular case can include linking previously unlinked identifiers from the software services by observing an expected behavioral pattern for using the multiple software services in a particular order pattern to respond to and close the particular case. In some implementations, the expected behavioral pattern can be company-dependent. In some implementations, the expected behavioral pattern can include ICIs including a timeframe defining an amount of time between a start time of the particular case and a next step performed by the customer service agent on the particular case. From 1506, method 1500 proceeds to 1508.

At 1508, a total period of time spent by the customer service agent on the particular case is determined based on a sum of focus event durations for the focus events assigned to the particular case. As an example, assigning a focus event to the particular case can include using clustering algorithms to identify and cluster a same customer corresponding to the particular case across the multiple software services. After 1508, method 1500 can stop.

FIG. 16 is a block diagram illustrating an environment 1600 that includes a user support improvement system 1601. The user support improvement system 1601 can be a part of the workforce analytics manager 101, for example. As described above, support representatives, such as a support representative 1602, can provide support for users, such as a user 1604. The support representative 1602 can perform support interactions using a computing device 1606 and/or other devices(s). The user 1604 can contact a support system using a device 1608, which may be a smartphone as illustrated (e.g., using a voice call and/or browser or application connection) or some other type of device.

The user support improvement system 1601 (or another system) can store, e.g., in a repository 1610 (or other repositories), user information, support representative information, and interaction information describing interactions that occur during various support cases. The user support improvement system 1601 can receive (e.g., retrieve or obtain) user support interaction data for specified user support interactions and user information not derived from the specified user support interactions, e.g., from the repository 1610 or another system. As described in more detail below, an expected value engine 1612 can determine, for users associated with the specified user support interactions, a first expected value of the user to an entity, e.g., a company, assuming the specified user support interactions occurred and a second expected value of the user to the entity assuming the specified user support interactions did not occur. That is, the expected value engine 1612 can predict changes in expected value that are expected to occur due to an incident or issue that caused a support case.

A user support analysis system 1614 can analyze the received user support interaction data, the user information not derived from the specified user support interactions, the expected value of the users to the entity assuming the specified user support interactions did not occur, and the expected value of the users to the entity given that the specified user support interactions did occur. In other words, the user support analysis system can analyze various types of information related to user support interactions, including information such as user conversations, user history, and support representative interactions. In some implementations, the user support analysis system 1614 can include different types of machine learning engines, such as supervised or unsupervised neural networks and regression models and/or different correlation engines.

Action data can be generated based on output of the user support analysis system 1614. Action data can include determining user support behavior or other characteristics that correlate to results of interest to an organization. For example, the user support analysis system 1614 can determine actual support interactions or other characteristics of a user, support representative, or other support context aspects that lead to an increase or decrease in user value (e.g., a change in purchase behavior), an increase or decrease in user retention (e.g., actual losing or maintaining of customers), or other results. Particularly, the user support analysis system 1614 can determine which interactions result in a retention (or in some cases an increase) in user value as compared to an expected change in user value that is predicted to occur due to an issue or incident that led to the user contacting support.

The user support analysis system 1614 can identify specific representatives whose actions, behaviors, or interventions lead to desired results such as user retention, user value increase, or preventing the loss of a customer due to a support incident. For instance, the user support analysis system 1614 can identify which representatives are performing work that leads to desired (or undesired) results, which specific actions the identified representatives perform in certain situations, which tools the representatives use in certain situations, which processes the representatives follow (or don't follow), or other work pattern behaviors.

An action engine 1616 can take action based on the action data. For example and as described in more detail below, action data can be surfaced and reported to interested parties. As another example, various specific personnel, tooling, training, and/or product development actions or investments can be performed. As another example, the user support analysis system 1614 and the action engine 1616 can be applied in real time to affect handling of current support cases, such as escalation, routing, or recommendations. In general, the action engine 1616 can identify and perform both real-time and aggregate actions whose estimated cost is less than a predicted benefit of user value savings or retention.

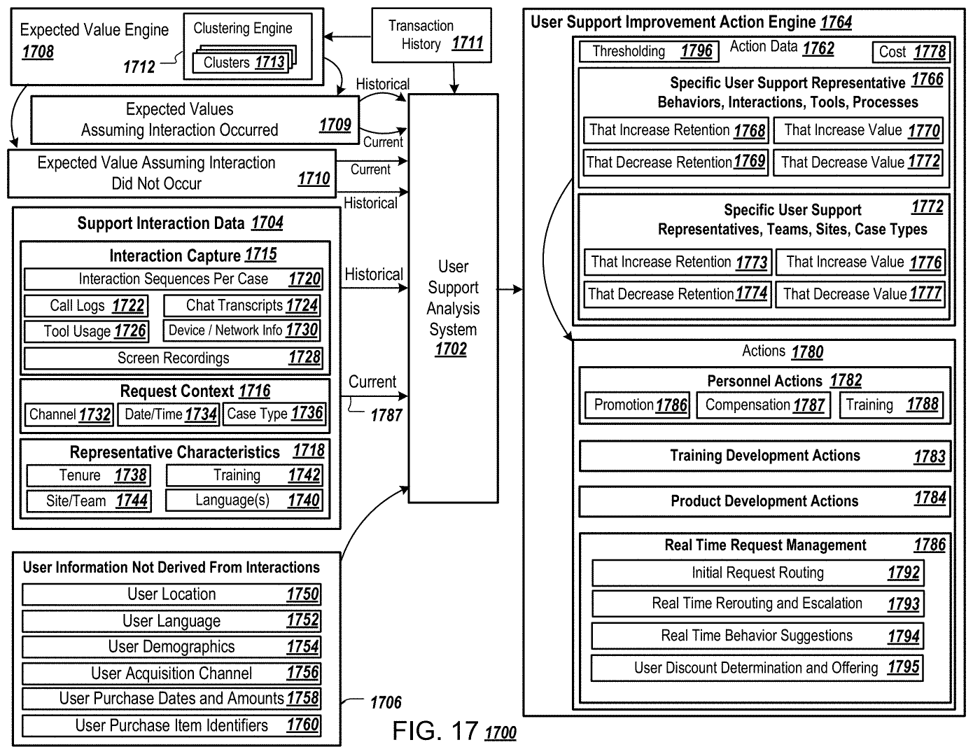

FIG. 17 is a diagram of the components of an exemplary user support improvement system 1700. A user support analysis system 1702 can analyze user support interaction data 1704, other user information 1706, and expected user (e.g., customer) value outputs generated by an expected value engine 1708. For instance, the expected value engine 1708 can determine, for specified interactions, expected value data 1709 assuming that the specified interactions occurred, and expected value data 1710 assuming that the specified interactions did not occur.

The expected value data 1710 assuming that the specified interactions did not occur can be predictions of future customer value and can be based on purchase data for respective users for time periods before the specified interactions and users similar to the respective users. For example, the expected value engine 1708 can evaluate a frequency and amount of historical transactions 1711 and perform a linear regression or other prediction model to predict future transactions (and thus future value). As another example, as an alternative or additional approach, a clustering engine 1712 can create clusters 1713 of similar customers (e.g., based on similar characteristics including purchases of same or similar items) and can evaluate historical transactions 1711 of similar clusters of users to determine an expected value data 1710 assuming that the specified interactions did not occur for a given customer based on the historical transactions 1711 of the given customer and similar customers. For example, purchase data for similar customers who have a longer tenure than the given customer can be used to predict future purchases for the given customer.

The expected value data 1709 assuming the specified interactions occurred can be a predicted change in expected value due to the incident or issue that caused the user to contact support, for example. The expected value engine 1708 can estimate a predicted change (e.g., drop) in expected value based on historical changes in expected value that occurred for similar problems for similar customers.

The user support interaction data 1704 includes interaction capture data 1715 for captured support interactions and other related information, such as support request context data 1716 and support representative characteristic data 1718. The interaction capture data 1715 includes captured interaction sequences 1720 for each case for which interactions are captured. Interaction sequences 1720 can include sequences of events as described above.

The interaction capture data 1715 includes call logs 1722, chat transcripts 1724, tool usage information 1726 regarding tools used for interactions, and screen recording information 1728. The interaction capture data 1714 can also include device/network information 1730, such as device hardware characteristics of devices used for the interactions, device performance information during interactions, and/or network performance information during interactions. The interaction capture data 1715 can include other information, such as information about keywords used by the user, response time, number of back-and-forth interactions occurred between the user and the support representative, hold time, total time to first response, total time to resolution.

The support request context data 1716 can include channel indications 1732 of channels on which requests occurred, such as phone, email, chat, etc., and/or whether the channel is an asynchronous or synchronous channel The support request context data 1716 can also include date/time information regarding requests, such as the date and time of a request, time of day information (e.g., morning, afternoon, evening), day of week information (e.g., weekday, weekend), and/or time of year information (e.g., season, holiday or non-holiday, etc.). The support request context data 1716 can include a case type 1736 (e.g., hardware issue, software issue, defective product) that has been selected or derived for a case for which interactions have been captured.

The representative characteristic data 1718 includes information regarding representative(s) who performed the captured interactions. For example, representative tenure 1738 and language(s) spoken 1740 by representatives can be provided as inputs to the user support analysis system 1702. As other examples, the representative characteristic data 1718 can include training information 1742 (e.g., amount and length of training previously obtained by representatives) and site/team information 1744 (e.g., geographic location, site information, team membership of representatives, how many representatives participated on the case, etc.). When more than one representative participates on a case, representative characteristic data 1718 for each representative can be provided as input(s) to the user support analysis system 1702. Other representative characteristic data 1718 can include how many hours per week the representative works and whether given cases were routed to the representative based on availability or expertise. Site/team information 1744 can also include information indicating which contact center to which a case was routed, labor laws applicable to team members working at the site.

The other user information 1706 includes user information not derived from support interactions. For example, the other user information 1706 can include user location 1750, user language 1752 (e.g., primary language and/or language(s) used), other user demographics 1754, and user acquisition channel 1756 (e.g., channel used to initially acquire the user). The other user information 1706 can also include purchase information for the user, such as user purchase dates and amounts 1758 and purchased item identifiers 1760.

As mentioned, the user support analysis system 1702 can analyze the user support interaction data 1704, the other user information 1706, the expected value data 1709 assuming that specified interactions occurred, and the expected value data 1710 assuming that the specified interactions did not occur. As mentioned, the user support analysis system 1702 can include one or more machine learning models that can be trained on the user support interaction data 1704, the other user information 1706, the expected value data 1709 assuming that specified interactions occurred, and the expected value data 1710 assuming that the specified interactions did not occur. As another example, the user support analysis system 1702 can include one or more correlation engines. The user support analysis system 1702 can generate, based on results of analyzing the user support interaction data 1704, the other user information 1706, the expected value data 1709 assuming that specified interactions occurred, and the expected value data 1710 assuming that the specified interactions did not occur, action data 1762 which can be provided to a user support improvement action engine 1764. The user support improvement action engine 1764 can be a part of the user support analysis system 1702 or can be a separate component from the user support analysis system 1702.

The action data 1762 generated by the user support analysis system 1702 can include information 1766 regarding specific user support representative behaviors, interactions, tools, or processes. For example, the action data 1762 can indicate which specific user support representative behaviors, interactions, tools, or processes resulted in (or correlate to) increased user retention 1768, decreased user retention 1769, increased user value 1770, or decreased user value 1771.

Similarly, the action data 1762 can include information 1772 regarding specific user support representatives, teams, sites, and case types, such as which interactions involving which specific representatives, teams, sites, and/or case types increased (or correlate to) increased user retention 1773, decreased user retention 1784, increased user value 1775, or decreased user value 1776. Additionally, the action data 1762 can indicate which combinations of factors (e.g., certain representatives using certain tools at certain sites) increased or decreased user retention and/or value). Although increase/decrease in user retention and user value are described, other outputs can be produced by the user support analysis system 1702. For example, support cost 1778 for the interactions that either increased or decreased user retention or user value can be determined.

The user support improvement action engine 1764 can perform various actions based on the action data 1762. For example, the user support improvement action engine 1764 can surface some or all of the action data 1762 to one or more interested parties. As another example, the user support improvement action engine 1764 can perform one or more actions 1780 based on the action data 1762. For example, the actions 1780 taken based on the action data 1762 can include personnel actions 1782, training development actions 1783, and product development actions 1784.

The personnel actions 1782 can include promotion actions 1786 and/or compensation actions 1787 for promoting (or demoting) and/or increasing (or decreasing) compensation for specific representatives based on correlated increase or decrease in user retention or value, respectively. The personnel actions 1782 can also include personnel training actions 1788 regarding assignment or recommendation for specific types of training for specific representatives (and/or for specific sites or teams), such as for representatives or teams whose interaction behaviors have had an adverse effect on user retention and/or user value (or whose interactions match interactions known to have an adverse effect on user retention and/or user value).

The training development actions 1783 can recommend development (or modification) of various training materials or procedures, based on which processes or sequences of interactions were determined to be most successful (or unsuccessful) regarding maintaining or increasing user retention or value, respectively. As another example, representatives, teams, and/or sites that are correlated to particularly high user retention and/or user value increase can be used as models (or even as trainers or training developers) for future training material.

Personnel actions 1782 and/or training actions 1788 can be taken for representatives who have high efficiency ratings but whose behavior is correlated to a decrease in user value and/or user retention as compared to other representatives. Some behaviors or interaction patterns, although efficient, may result in undesirable results, for example. Representatives (and/or representative managers) can be informed, and appropriate training or personnel decisions or actions can be made to make changes to representative behavior.

As another example, use of productive tools that are correlated to user retention and/or increased user value can become more featured in training material. As another example, deployment of productive tools can be increased and/or standardized if needed. Unproductive tools that are correlated to lack of user retention and/or decrease in user value can be removed from training materials and/or have their use flagged as deprecated. Additionally or alternatively, unproductive tools can be removed from support representative workstations.

A length of a training program can be determined by analyzing a length of tenure and/or an amount of training previously obtained by representatives whose behaviors are correlated to user retention and/or increased user value. In general and in summary, training operations can be tailored based on representative characteristics and behaviors of representatives that are correlated to highest user retention and/or highest increase in user value.

Product development actions 1784 can include providing data to product development teams regarding, for example, particular case types that correlate to lost revenue and/or lost customers, so that the product development teams can prioritize fixing root causes of issues related to those particular case types. Prioritizing product development on case types that correlate to lost revenue and/or lost customers can result in future reduction of those types of cases, and thus reduction in associated lost revenue and/or lost customers that may have otherwise occurred.

The user support analysis system 1702 and the user support improvement engine 1764 can also be applied for real time request management actions 1786 for a current support request. Current support interaction data 1704 for a current support request can be provided to the user support analysis system 1702, for example. The user support analysis system 1702 (and/or the expected value engine 1708) can determine an expected value 1709 for the user based on the current support interaction data 1704 for the current support request in progress. In some cases, real time request management actions 1790 can include initial request routing 1792. For instance, a request can be routed to a channel, agent, site, or team based on a predicted expected user value (or change in user value) that is predicted to occur if the request is handled by a particular channel, agent, site, or team.

After initial request routing, real time actions can include real time rerouting and escalation actions 1793. For example, the user support analysis system 1702 can predict the expected value 1708 (or a change in expected value) that is expected to occur if the representative behavior patterns (and other request or support interaction characteristics, such as the channel being used, the actual representative(s) being used, the site being used, etc.) continue to be used for the remainder of the support case. If a current or predicted user support resolution is not predictive of retaining value, the support request can be escalated and/or rerouted to another agent, team, site, or channel that has a higher likelihood of retaining value.

For example, the user support analysis system 1702 can predict that twice as much retention of user value may occur if the request is routed from a chat to a live agent on a telephone line. A potential gain in retention of value can be considered in light of additional costs that may occur if a support request is rerouted or escalated. A phone call may cost more than a chat, for example (e.g., due to agents being able to handle multiple chat requests simultaneously as compared to handling one phone call). The user support improvement action engine 1764 can determine to reroute a request if a difference in user value retention between a new agent, site, team, or channel and a current agent, site, team, or channel is more than a threshold amount larger than an increase in cost that may occur from rerouting. If a difference between a gain in user retention and an increase in cost is less than the threshold, the user support improvement action engine 1764 may determine to not reroute the request. For instance, if rerouting the request would only save a lifetime user value amount of one dollar, the request may not be rerouted, for convenience of the user (and in some cases, convenience of the representative and corresponding teams/sites).

In general, the user support improvement action engine 1764 can determine whether to perform an action (e.g., either a real-time action or an aggregate action that affects multiple representatives or sites) by using a thresholding engine 1796 that determines whether the cost 1778 of the action is at least a threshold amount less than a predicted net positive effect on expected value. Additionally, which types of actions to perform, and how to perform selected actions (e.g., which representative, site, or process to use) can be selected based on which action, which type of action, or which parameters of a certain action maximize a difference between a predicted net positive effect on expected value and a cost of the respective action.

As another example, user discount determination and presentation actions 1794 can be taken, for example, in response to proposed (or recent) support interactions that are not predictive of retaining value. For instance, the user support analysis system 1702 may determine, given the interactions that have occurred thus far for a support request, an expected user value that may indicate a decrease in user value. That is, given that the interactions have occurred thus far in the handling of the request, the user support analysis system 1702 may predict a decrease in user value. Accordingly, the user support improvement action engine 1764 can determine to recommend an offering of a discount (or a refund) to the user, e.g., when a refund or discount may otherwise not have been offered. The discount or refund may have an effect of stopping or reducing the reduction in user value. The offering of the discount or refund, and future user purchase activity can subsequently be used as part of updating the user support analysis system 1702 so that the user support analysis system 1702 learns (or better learns) over time what types of discounts or refunds (and what timing of discount or refund offers) have a positive effect on retaining user value.

Real time behavior suggestion actions 1794 can be performed to recommend, e.g., in a dynamic user interface, behavior suggestions to representatives for recommended interactions (or change in interactions) that, if taken, may result in an increase in user value and/or an increase in user retention. The user support analysis system 1702 can determine specific initial behaviors for a request based on user characteristics, case type, representative characteristics, etc., for presentation to the representative. Additionally or alternatively, the user support analysis system 1702 can evaluate interactions performed thus far for a request, and determine recommended midstream interactions that, if taken, may result in an increase in user value and/or an increase in user retention.

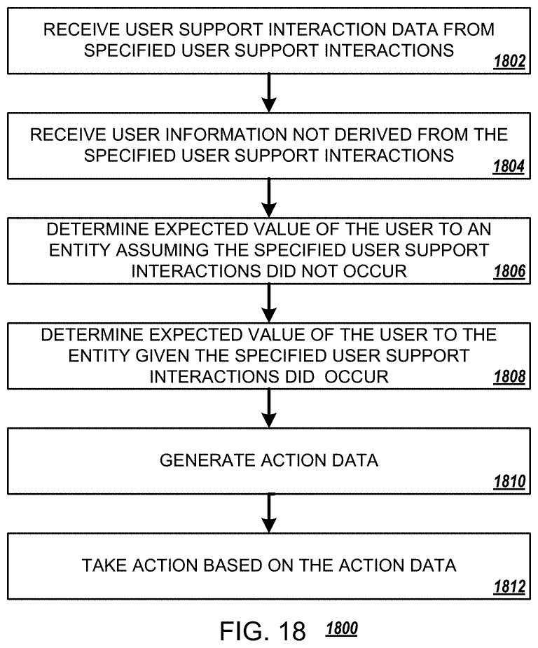

FIG. 18 is a flowchart of an example process 1800 for retaining value through user support interaction analytics. For convenience, the process 1800 will be described as being performed by a system of one or more computers, located in one or more locations, and programmed appropriately in accordance with this specification. For example, a user support interaction analytics system, e.g., the user support interaction analytics system 100 of FIG. 1, appropriately programmed, can perform the process 1800.

The user support interaction analytics system receives user support interaction data derived from specified user support interactions (1802).

The user support interaction analytics system receives user information not derived from the specified user support interactions (1804).

The user support interaction analytics system determines an expected value of the user to an entity assuming the specified user support interactions did not occur (1806).

The user support interaction analytics system determines the expected value of the user to the entity given that the specified user support interactions did occur (1808).

The user support interaction analytics system generates action data (1810). The action data is generated based on i) the user support interaction data, ii) the user information not derived from the specified user support interactions, iii) the expected value of the user to the entity assuming the specified user support interaction did not occur, and iv) the expected value of the user to the entity given that the specified user support interaction did occur. In some implementations, the action data is generated based on a model that is trained on the user support interaction data, the user information not derived from the specified user support interactions, the expected value of the user to the entity assuming the specified user support interaction did not occur, and the expected value of the user to the entity given that the specified user support interaction did occur. In other cases, the action data is generated based on results of different correlation engines.

The user support interaction analytics system takes action based on the action data (1812). Actions can include determining which user support representative behaviors correlate with maintaining a user, determining which user support representative tools increase user retention, determining which user support representatives have a rate of retaining users above a specified threshold, determining which user support representative teams have a rate of retaining users above a threshold (e.g., a predetermined or a dynamic threshold), determining a length of a training program based on the action data, determining which user support interactions lead to lost value or increased value above a specified threshold.

Some actions can involve handling of a current user support request. For example, actions can include escalating a user support request when a proposed user support resolution is not predictive of retaining value or providing value (e.g., a discount) to a user when a proposed user support resolution is not predictive of retaining value.

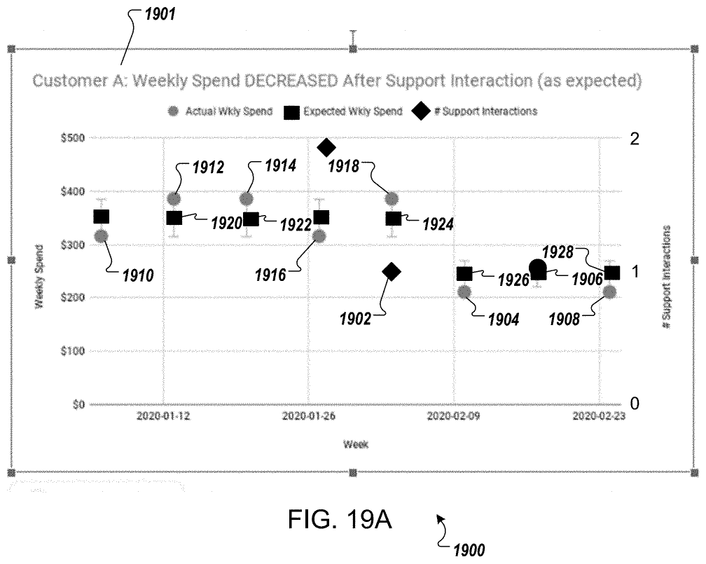

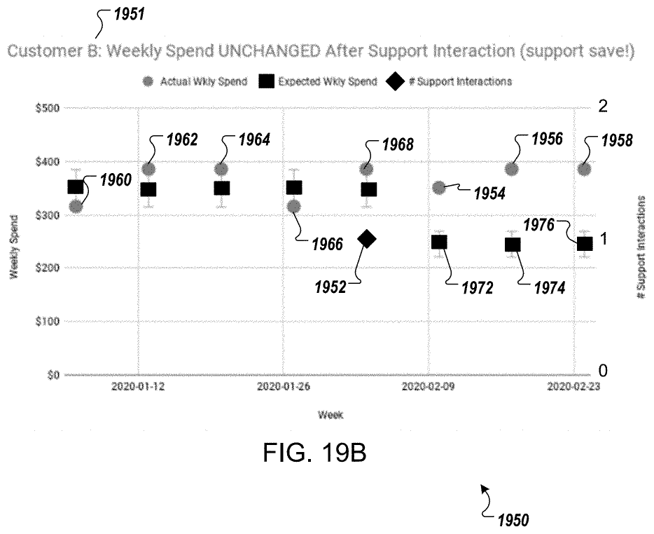

FIG. 19A is a graph 1900 of weekly spend decreased after a user support interaction. The graph 1900 plots time on the X-axis and weekly spend and number of support interactions on the Y-axis for a particular customer (e.g., customer “A” 1901). For example, an interaction indicator 1902 indicates that a support interaction occurred for the customer A 1901 in early February 2020. The support interaction occurred, for example, due to an issue that the customer A 1901 had with an offered product or service. Customer dissatisfaction related to the issue can cause a decrease in weekly spend. For example, actual weekly spend amounts for weeks after the support interaction are generally less than actual weekly spend amounts before the support interaction. For instance, post-interaction actual weekly spend indicators 1904, 1906, and 1908 indicate lower post-interaction weekly spend than pre-weekly spend indicated by pre-interaction weekly spend indicators 1910, 1912, 1914, 1916, and 1918. Additionally, a majority of pre-interaction weeks had actual weekly spend amounts greater than corresponding expected weekly spend amounts (e.g., actual weekly spend amounts corresponding to the pre-interaction weekly spend indicators 1912, 1914, and 1918 were greater than corresponding expected weekly spend amounts reflected by expected pre-interaction weekly spend indicators 1920, 1922, and 1924, respectively). In contrast, a majority of post-interaction weeks had actual weekly spend amounts less than corresponding expected weekly spend amounts (e.g., actual weekly spend amounts corresponding to the post-interaction weekly spend indicators 1904 and 1906 were less than corresponding expected weekly spend amounts reflected by expected post-interaction weekly spend indicators 1926 and 1928, respectively).

FIG. 19B is a graph 1950 of weekly spend largely unchanged after a user support interaction. Similar to the graph 1900 described above with respect to FIG. 19A, the graph 1950 plots time on the X-axis and weekly spend and number of support interactions on the Y-axis for a particular customer (e.g., customer “B” 1951). An interaction indicator 1952 indicates that a support interaction occurred for the customer B 1951 in early February 2020. Although the support interaction occurred, for example, due to an issue that the customer B 1951 had with an offered product or service, actions taken based on action data generated by a machine learning model or analysis system can prevent or decrease customer dissatisfaction and also prevent an otherwise expected drop in weekly spend.

For example, actual weekly spend amounts for weeks after the support interaction generally follow a similar pattern as actual weekly spend amounts before the support interaction. For instance, post-interaction actual weekly spend indicators 1954, 1956, and 1958 indicate similar post-interaction weekly spend as compared to pre-weekly spend indicated by pre-interaction weekly spend indicators 1960, 1962, 1964, 1966, and 1968. Additionally, the post-interaction weeks had actual weekly spend amounts greater than corresponding expected weekly spend amounts (e.g., actual weekly spend amounts corresponding to the post-interaction weekly spend indicators 1954, 1956, and 1958 are each greater than corresponding expected weekly spend amounts reflected by expected post-interaction weekly spend indicators 1970, 1972, and 1974, respectively). For instance, expected weekly spend amounts can be calculated to factor in an expected drop in weekly spend after a support interaction. The graph 1950 generally shows results of successful support interactions that retained user value, despite the customer issue that caused the customer to contact a support system.

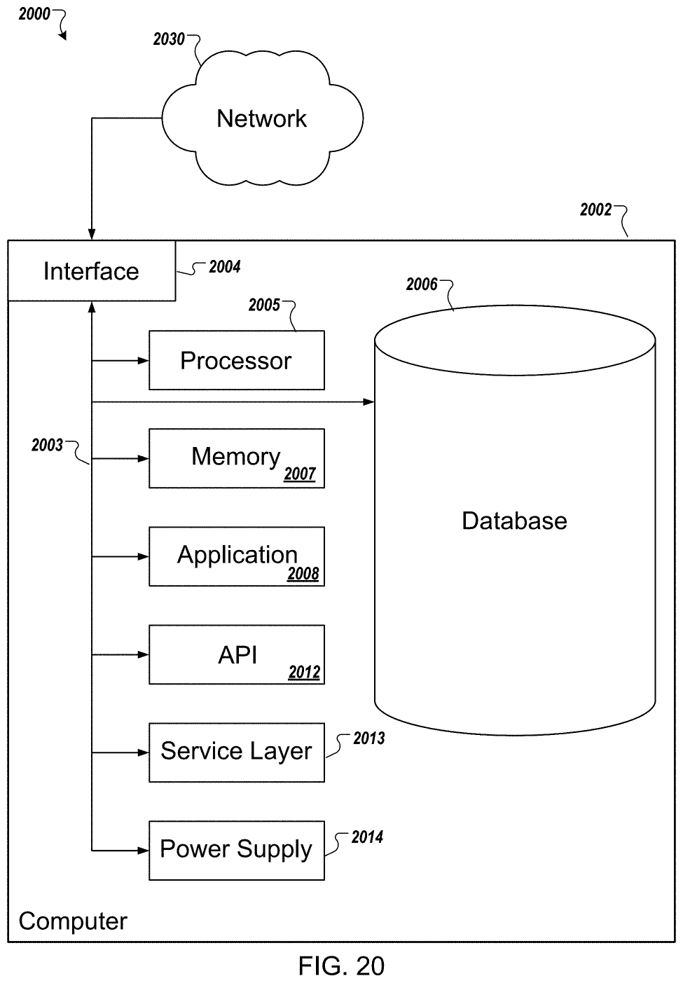

FIG. 20 is a block diagram of an example computer system 2000 used to provide computational functionalities associated with described algorithms, methods, functions, processes, flows, and procedures described in the present disclosure, according to some implementations of the present disclosure. The illustrated computer 2002 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 2002 can include input devices such as keypads, keyboards, and touch screens that can accept user information. Also, the computer 2002 can include output devices that can convey information associated with the operation of the computer 2002. The information can include digital data, visual data, audio information, or a combination of information. The information can be presented in a graphical user interface (UI) (or GUI).

The computer 2002 can serve in a role as a client, a network component, a server, a database, a persistency, or components of a computer system for performing the subject matter described in the present disclosure. The illustrated computer 2002 is communicably coupled with a network 2030. In some implementations, one or more components of the computer 2002 can be configured to operate within different environments, including cloud-computing-based environments, local environments, global environments, and combinations of environments.

At a top level, the computer 2002 is an electronic computing device operable to receive, transmit, process, store, and manage data and information associated with the described subject matter. According to some implementations, the computer 2002 can also include, or be communicably coupled with, an application server, an email server, a web server, a caching server, a streaming data server, or a combination of servers.

The computer 2002 can receive requests over network 2030 from a client application (for example, executing on another computer 2002). The computer 2002 can respond to the received requests by processing the received requests using software applications. Requests can also be sent to the computer 2002 from internal users (for example, from a command console), external (or third) parties, automated applications, entities, individuals, systems, and computers.

Each of the components of the computer 2002 can communicate using a system bus 2003. In some implementations, any or all of the components of the computer 2002, including hardware or software components, can interface with each other or the interface 2004 (or a combination of both) over the system bus 2003. Interfaces can use an application programming interface (API) 2012, a service layer 2013, or a combination of the API 2012 and service layer 2013. The API 2012 can include specifications for routines, data structures, and object classes. The API 2012 can be either computer-language independent or dependent. The API 2012 can refer to a complete interface, a single function, or a set of APIs.

The service layer 2013 can provide software services to the computer 2002 and other components (whether illustrated or not) that are communicably coupled to the computer 2002. The functionality of the computer 2002 can be accessible for all service consumers using this service layer. Software services, such as those provided by the service layer 2013, can provide reusable, defined functionalities through a defined interface. For example, the interface can be software written in JAVA, C++, or a language providing data in extensible markup language (XML) format. While illustrated as an integrated component of the computer 2002, in alternative implementations, the API 2012 or the service layer 2013 can be stand-alone components in relation to other components of the computer 2002 and other components communicably coupled to the computer 2002. Moreover, any or all parts of the API 2012 or the service layer 2013 can be implemented as child or sub-modules of another software module, enterprise application, or hardware module without departing from the scope of the present disclosure.

The computer 2002 includes an interface 2004. Although illustrated as a single interface 2004 in FIG. 20, two or more interfaces 2004 can be used according to particular needs, desires, or particular implementations of the computer 2002 and the described functionality. The interface 2004 can be used by the computer 2002 for communicating with other systems that are connected to the network 2030 (whether illustrated or not) in a distributed environment. Generally, the interface 2004 can include, or be implemented using, logic encoded in software or hardware (or a combination of software and hardware) operable to communicate with the network 2030. More specifically, the interface 2004 can include software supporting one or more communication protocols associated with communications. As such, the network 2030 or the interface's hardware can be operable to communicate physical signals within and outside of the illustrated computer 2002.

The computer 2002 includes a processor 2005. Although illustrated as a single processor 2005 in FIG. 20, two or more processors 2005 can be used according to particular needs, desires, or particular implementations of the computer 2002 and the described functionality. Generally, the processor 2005 can execute instructions and can manipulate data to perform the operations of the computer 2002, including operations using algorithms, methods, functions, processes, flows, and procedures as described in the present disclosure.

The computer 2002 also includes a database 2006 that can hold data for the computer 2002 and other components connected to the network 2030 (whether illustrated or not). For example, database 2006 can be an in-memory, conventional, or a database storing data consistent with the present disclosure. In some implementations, database 2006 can be a combination of two or more different database types (for example, hybrid in-memory and conventional databases) according to particular needs, desires, or particular implementations of the computer 2002 and the described functionality. Although illustrated as a single database 2006 in FIG. 20, two or more databases (of the same, different, or combination of types) can be used according to particular needs, desires, or particular implementations of the computer 2002 and the described functionality. While database 2006 is illustrated as an internal component of the computer 2002, in alternative implementations, database 2006 can be external to the computer 2002.

The computer 2002 also includes a memory 2007 that can hold data for the computer 2002 or a combination of components connected to the network 2030 (whether illustrated or not). Memory 2007 can store any data consistent with the present disclosure. In some implementations, memory 2007 can be a combination of two or more different types of memory (for example, a combination of semiconductor and magnetic storage) according to particular needs, desires, or particular implementations of the computer 2002 and the described functionality. Although illustrated as a single memory 2007 in FIG. 20, two or more memories 2007 (of the same, different, or combination of types) can be used according to particular needs, desires, or particular implementations of the computer 2002 and the described functionality. While memory 2007 is illustrated as an internal component of the computer 2002, in alternative implementations, memory 2007 can be external to the computer 2002.

The application 2008 can be an algorithmic software engine providing functionality according to particular needs, desires, or particular implementations of the computer 2002 and the described functionality. For example, application 2008 can serve as one or more components, modules, or applications. Further, although illustrated as a single application 2008, the application 2008 can be implemented as multiple applications 2008 on the computer 2002. In addition, although illustrated as internal to the computer 2002, in alternative implementations, the application 2008 can be external to the computer 2002.

The computer 2002 can also include a power supply 2014. The power supply 2014 can include a rechargeable or non-rechargeable battery that can be configured to be either user- or non-user-replaceable. In some implementations, the power supply 2014 can include power-conversion and management circuits, including recharging, standby, and power management functionalities. In some implementations, the power-supply 2014 can include a power plug to allow the computer 2002 to be plugged into a wall socket or a power source to, for example, power the computer 2002 or recharge a rechargeable battery.

There can be any number of computers 2002 associated with, or external to, a computer system containing computer 2002, with each computer 2002 communicating over network 2030. Further, the terms “client,” “user,” and other appropriate terminology can be used interchangeably, as appropriate, without departing from the scope of the present disclosure. Moreover, the present disclosure contemplates that many users can use one computer 2002 and one user can use multiple computers 2002.

Described implementations of the subject matter can include one or more features, alone or in combination. For example, in a first implementation, a computer-implemented method includes the actions of: receiving user support interaction data derived from specified user support interactions; receiving user information not derived from the specified user support interactions; determining expected value of the user to an entity assuming the specified user support interactions did not occur; determining the expected value of the user to the entity given that the specified user support interactions did occur; generating action data using a model trained on i) the user support interaction data, ii) the user information not derived from the specified user support interaction, iii) the expected value of the user to the entity assuming the specified user support interactions did not occur, and iv) the expected value of the user to the entity given that the specified user support interactions did occur; and taking action based on the action data.

The foregoing and other described implementations can each, optionally, include one or more of the following features:

A first feature, combinable with any of the following features, wherein the action comprises determining which user support representative behaviors correlate with maintaining a user.

A second feature, combination with any of the previous or following features, wherein the action comprises determining which user support representative tools increase user retention.

A third feature, combination with any of the previous or following features, wherein the action comprises determining which user support representatives have a rate of retaining users above a specified threshold.

A fourth feature, combination with any of the previous or following features, wherein the action comprises determining which user support representative teams have a higher rate of retaining users.

A fifth feature, combination with any of the previous or following features, wherein the action comprises determining a length of a training program based on the action data.

A sixth feature, combination with any of the previous or following features, wherein the action comprises determining which user support interactions lead to lost value or increased value above a specified threshold.

A seventh feature, combination with any of the previous or following features, wherein the action comprises escalating a user support request when a proposed user support resolution is not predictive of retaining value.

An eighth feature, combination with any of the previous or following features, wherein the method includes: using the model to predict an expected change in user value to the entity based on the occurrence of the user support request; determining a cost of a candidate escalation action to perform for the user support request; determining that the expected change in user value to the entity is greater than the cost of the candidate escalation by at least a threshold amount; and performing the candidate escalation action based on determining that the expected change in user value to the entity is greater than the cost of the candidate escalation by at least the threshold amount.

A ninth feature, combination with any of the previous or following features, wherein the action comprises providing value to a user when a proposed user support resolution is not predictive of retaining value.

In a second implementation, a computer-implemented method includes the actions of: receiving customer support data derived from a specified customer support interaction; receiving customer information not derived from the specified customer support interaction; determining expected value of the customer assuming the specified customer support interaction did not occur; generating action data using a model trained on the customer support interaction data, the customer information not derived from the specified customer support interaction, the expected value of the customer assuming the specified customer support interaction did not occur, and expected value of the customer given that the specified customer support interaction did occur; and taking action based on the action data.

The foregoing and other described implementations can each, optionally, include one or more of the following features:

A first feature, combinable with any of the following features, wherein the action comprises determining which user support representative behaviors correlate with maintaining a user.

A second feature, combination with any of the previous or following features, wherein the action comprises determining which user support representative tools increase user retention.

A third feature, combination with any of the previous or following features, wherein the action comprises determining which user support representatives have a rate of retaining users above a specified threshold.

A fourth feature, combination with any of the previous or following features, wherein the action comprises determining which user support representative teams have a higher rate of retaining users.

A fifth feature, combination with any of the previous or following features, wherein the action comprises determining a length of a training program based on the action data.

A sixth feature, combination with any of the previous or following features, wherein the action comprises determining which user support interactions lead to lost value or increased value above a specified threshold.

A seventh feature, combination with any of the previous or following features, wherein the action comprises escalating a user support request when a proposed user support resolution is not predictive of retaining value.

An eighth feature, combination with any of the previous or following features, wherein the method includes: using the model to predict an expected change in user value to the entity based on the occurrence of the user support request; determining a cost of a candidate escalation action to perform for the user support request; determining that the expected change in user value to the entity is greater than the cost of the candidate escalation by at least a threshold amount; and performing the candidate escalation action based on determining that the expected change in user value to the entity is greater than the cost of the candidate escalation by at least the threshold amount.

A ninth feature, combination with any of the previous or following features, wherein the action comprises providing value to a user when a proposed user support resolution is not predictive of retaining value.

In a third implementation, a non-transitory, computer-readable medium stores one or more instructions executable by a computer system to perform operations including: receiving user support interaction data derived from specified user support interactions; receiving user information not derived from the specified user support interactions; determining expected value of the user to an entity assuming the specified user support interactions did not occur; determining the expected value of the user to the entity given that the specified user support interactions did occur; generating action data using a model trained on i) the user support interaction data, ii) the user information not derived from the specified user support interaction, iii) the expected value of the user to the entity assuming the specified user support interactions did not occur, and iv) the expected value of the user to the entity given that the specified user support interactions did occur; and taking action based on the action data.

The foregoing and other described implementations can each, optionally, include one or more of the following features:

A first feature, combinable with any of the following features, wherein the action comprises determining which user support representative behaviors correlate with maintaining a user.

A second feature, combination with any of the previous or following features, wherein the action comprises determining which user support representative tools increase user retention.

A third feature, combination with any of the previous or following features, wherein the action comprises determining which user support representatives have a rate of retaining users above a specified threshold.

A fourth feature, combination with any of the previous or following features, wherein the action comprises determining which user support representative teams have a higher rate of retaining users.

A fifth feature, combination with any of the previous or following features, wherein the action comprises determining a length of a training program based on the action data.

A sixth feature, combination with any of the previous or following features, wherein the action comprises determining which user support interactions lead to lost value or increased value above a specified threshold.

A seventh feature, combination with any of the previous or following features, wherein the action comprises escalating a user support request when a proposed user support resolution is not predictive of retaining value.

An eighth feature, combination with any of the previous or following features, wherein the method includes: using the model to predict an expected change in user value to the entity based on the occurrence of the user support request; determining a cost of a candidate escalation action to perform for the user support request; determining that the expected change in user value to the entity is greater than the cost of the candidate escalation by at least a threshold amount; and performing the candidate escalation action based on determining that the expected change in user value to the entity is greater than the cost of the candidate escalation by at least the threshold amount.

A ninth feature, combination with any of the previous or following features, wherein the action comprises providing value to a user when a proposed user support resolution is not predictive of retaining value.

In a fourth implementation, a system comprises one or more computers and one or more storage devices on which are stored instructions that are operable, when executed by the one or more computers, to cause the one or more computers to perform operations. The operations include: receiving user support interaction data derived from specified user support interactions; receiving user information not derived from the specified user support interactions; determining expected value of the user to an entity assuming the specified user support interactions did not occur; determining the expected value of the user to the entity given that the specified user support interactions did occur; generating action data using a model trained on i) the user support interaction data, ii) the user information not derived from the specified user support interaction, iii) the expected value of the user to the entity assuming the specified user support interactions did not occur, and iv) the expected value of the user to the entity given that the specified user support interactions did occur; and taking action based on the action data.

The foregoing and other described implementations can each, optionally, include one or more of the following features:

A first feature, combinable with any of the following features, wherein the action comprises determining which user support representative behaviors correlate with maintaining a user.

A second feature, combination with any of the previous or following features, wherein the action comprises determining which user support representative tools increase user retention.

A third feature, combination with any of the previous or following features, wherein the action comprises determining which user support representatives have a rate of retaining users above a specified threshold.

A fourth feature, combination with any of the previous or following features, wherein the action comprises determining which user support representative teams have a higher rate of retaining users.

A fifth feature, combination with any of the previous or following features, wherein the action comprises determining a length of a training program based on the action data.

A sixth feature, combination with any of the previous or following features, wherein the action comprises determining which user support interactions lead to lost value or increased value above a specified threshold.

A seventh feature, combination with any of the previous or following features, wherein the action comprises escalating a user support request when a proposed user support resolution is not predictive of retaining value.

An eighth feature, combination with any of the previous or following features, wherein the method includes: using the model to predict an expected change in user value to the entity based on the occurrence of the user support request; determining a cost of a candidate escalation action to perform for the user support request; determining that the expected change in user value to the entity is greater than the cost of the candidate escalation by at least a threshold amount; and performing the candidate escalation action based on determining that the expected change in user value to the entity is greater than the cost of the candidate escalation by at least the threshold amount.

A ninth feature, combination with any of the previous or following features, wherein the action comprises providing value to a user when a proposed user support resolution is not predictive of retaining value.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
receiving user support interaction data derived from specified user support interactions;
receiving user information not derived from the specified user support interactions;
determining expected value of the user to an entity assuming the specified user support interactions did not occur;
determining the expected value of the user to the entity given that the specified user support interactions did occur;
generating action data based on i) the user support interaction data, ii) the user information not derived from the specified user support interactions, iii) the expected value of the user to the entity assuming the specified user support interactions did not occur, and iv) the expected value of the user to the entity given that the specified user support interactions did occur; and
taking action based on the action data.

2. The computer-implemented method of claim 1 wherein the action comprises determining which user support representative behaviors correlate with maintaining a user.

3. The computer-implemented method of claim 1 wherein the action comprises determining which user support representative tools increase user retention.

4. The computer-implemented method of claim 1 wherein the action comprises determining which user support representatives have a rate of retaining users above a specified threshold.

5. The computer-implemented method of claim 1 wherein the action comprises determining which user support representative teams have a higher rate of retaining users.

6. The computer-implemented method of claim 1 wherein the action comprises determining a length of a training program based on the action data.

7. The computer-implemented method of claim 1 wherein the action comprises determining which user support interactions lead to lost value or increased value above a specified threshold.

8. The computer-implemented method of claim 1 wherein the action comprises escalating a user support request when a proposed user support resolution is not predictive of retaining value.

9. The computer-implemented method of claim 1, wherein the action data is generated using a model trained on i) the user support interaction data, ii) the user information not derived from the specified user support interactions, iii) the expected value of the user to the entity assuming the specified user support interactions did not occur, and iv) the expected value of the user to the entity given that the specified user support interactions did occur.

10. The computer-implemented method of claim 9, further comprising:
using the model to predict an expected change in user value to the entity based on an occurrence of the user support request;
determining a cost of a candidate escalation action to perform for the user support request;
determining that the expected change in user value to the entity is greater than the cost of the candidate escalation by at least a threshold amount; and
performing the candidate escalation action based on determining that the expected change in user value to the entity is greater than the cost of the candidate escalation by at least the threshold amount.

11. The computer-implemented method of claim 1 wherein the action comprises providing value to a user when a proposed user support resolution is not predictive of retaining value.

12. A computer-implemented method comprising:
receiving customer support data derived from a specified customer support interaction;
receiving customer information not derived from the specified customer support interaction;
determining expected value of the customer assuming the specified customer support interaction did not occur;
generating action data based on the customer support interaction data, the customer information not derived from the specified customer support interactions, the expected value of the customer assuming the specified customer support interaction did not occur, and expected value of the customer given that the specified customer support interaction did occur; and
taking action based on the action data.

13. One or more computer-readable storage media encoded with instructions that, when executed by one or more computers, cause the one or more computers to perform operations comprising:
receiving user support interaction data derived from specified user support interactions;
receiving user information not derived from the specified user support interactions;
determining expected value of the user to an entity assuming the specified user support interactions did not occur;
determining the expected value of the user to the entity given that the specified user support interactions did occur;
generating action data based on i) the user support interaction data, ii) the user information not derived from the specified user support interactions, iii) the expected value of the user to the entity assuming the specified user support interactions did not occur, and iv) the expected value of the user to the entity given that the specified user support interactions did occur; and
taking action based on the action data.

14. The computer-readable storage media of claim 13 wherein the action data is generated using a model trained on i) the user support interaction data, ii) the user information not derived from the specified user support interactions, iii) the expected value of the user to the entity assuming the specified user support interactions did not occur, and iv) the expected value of the user to the entity given that the specified user support interactions did occur.

15. The computer-readable storage media of claim 14 wherein the operations further comprise:
using the model to predict an expected change in user value to the entity based on an occurrence of the user support request;
determining a cost of a candidate escalation action to perform for the user support request;
determining that the expected change in user value to the entity is greater than the cost of the candidate escalation by at least a threshold amount; and
performing the candidate escalation action based on determining that the expected change in user value to the entity is greater than the cost of the candidate escalation by at least the threshold amount.

16. The computer-readable storage media of claim 13 wherein the action comprises determining which user support representative behaviors correlate with maintaining a user.

17. The computer-readable storage media of claim 13 wherein the action comprises determining which user support representative tools increase user retention.

18. A system comprising:
one or more computers and one or more storage devices on which are stored instructions that are operable, when executed by the one or more computers, to cause the one or more computers to perform operations comprising:
receiving user support interaction data derived from specified user support interactions;
receiving user information not derived from the specified user support interactions;
determining expected value of the user to an entity assuming the specified user support interactions did not occur;
determining the expected value of the user to the entity given that the specified user support interactions did occur;
generating action data based on i) the user support interaction data, ii) the user information not derived from the specified user support interactions, iii) the expected value of the user to the entity assuming the specified user support interactions did not occur, and iv) the expected value of the user to the entity given that the specified user support interactions did occur; and
taking action based on the action data.

19. The system of claim 18 wherein the action data is generated using a model trained on i) the user support interaction data, ii) the user information not derived from the specified user support interactions, iii) the expected value of the user to the entity assuming the specified user support interactions did not occur, and iv) the expected value of the user to the entity given that the specified user support interactions did occur.

20. The system of claim 19 wherein the operations further comprise:
using the model to predict an expected change in user value to the entity based on the occurrence of the user support request;
determining a cost of a candidate escalation action to perform for the user support request;
determining that the expected change in user value to the entity is greater than the cost of the candidate escalation by at least a threshold amount; and
performing the candidate escalation action based on determining that the expected change in user value to the entity is greater than the cost of the candidate escalation by at least the threshold amount.
